(19) United States
(12) Patent Application Publication
(10) Pub. No.: US 2014/0214373 A1
(43) Pub. Date: Jul. 31, 2014

(54) FRAMEWORK FOR SOLVING TRAJECTORY OPTIMIZATION PROBLEMS

(71) Applicant: THE MATHWORKS, INC., Natick, MA (US)

(72) Inventors: Matthew Jardin, Natick, MA (US); Baljeet Singh, Framingham, MA (US)

(73) Assignee: The MathWorks, Inc., Natick, MA (US)

(21) Appl. No.: 13/754,367

(22) Filed: Jan. 30, 2013

(51) Int. Cl. G06F 17/50

(52) U.S. Cl. CPC G06F 17/5018
USPC 703/2

(57) ABSTRACT

A method, performed by a computer device, may include generating a first executable graphical model representing a dynamic system and generating a second executable graphical model representing costs and constraints associated with the dynamic system. The method may further include generating an interface model based on the first and second executable graphical models; obtaining one or more solution parameters for solving a trajectory optimization problem defined by the dynamic system and the cost and constraints; expanding the generated interface model based on the obtained one or more solution parameters to generate a direct transcription representation of the trajectory optimization problem; evaluating the expanded interface model to obtain a solution to the trajectory optimization problem; and providing, in an interface, the solution as a solution to the trajectory optimization problem, wherein the solution has a reduced cost compared to a cost associated with an initial guess solution.

### BACKGROUND INFORMATION

A large variety of systems, such as mechanical systems, electrical systems, biological systems, and/or computer systems, may be represented as dynamic systems. Computational tools have been developed to model, simulate, and/or analyze dynamic systems. A computational tool may represent a dynamic system using a graphical model. The graphical model may include blocks that may represent components of the dynamic system. The blocks may be connected to represent relationships between the components. The computational tool may simulate the graphical model and may provide results of the simulation. One class of dynamic systems includes systems in which an object travels from a first location or state to a second location or state via a specific trajectory. It may be desirable to use a graphical model to model the trajectory of the object based on specified conditions. However, conventional graphical modeling applications may make it difficult or impossible to develop a satisfactory graphical model for computing trajectories based on specified conditions.

### BRIEF DESCRIPTION OF THE DRAWINGS

FIG. 1 is a diagram of a framework for generating a solution to a trajectory optimization problem according to an implementation described herein;

FIG. 2 is a diagram illustrating exemplary components of an environment for implementing the framework of FIG. 1 according to an implementation described herein;

FIG. 3 is a diagram illustrating exemplary components of the computer device of FIG. 2;

FIG. 4 is a diagram of exemplary components of a modeling system that may be included in the computer device of FIG. 2;

FIG. 5 is a diagram of exemplary functional components of the modeling system of FIG. 4;

FIG. 6 is a flow diagram of an exemplary process for generating a solution to a trajectory optimization problem according to an implementation described herein;

FIG. 7 is a flow diagram of an exemplary process for evaluating a direct transcription representation of a graphical model according to an implementation described herein;

FIG. 8 is a flow diagram of an exemplary process for determining a near optimal control solution according to an implementation described herein; and

FIGS. 9A-9I are exemplary diagrams of an example of using a framework to generate a solution to a trajectory optimization problem according to an implementation described herein.

### DETAILED DESCRIPTION OF PREFERRED EMBODIMENTS

The following detailed description refers to the accompanying drawings. The same reference numbers in different drawings identify the same or similar elements. Also, the following detailed description does not limit the invention.

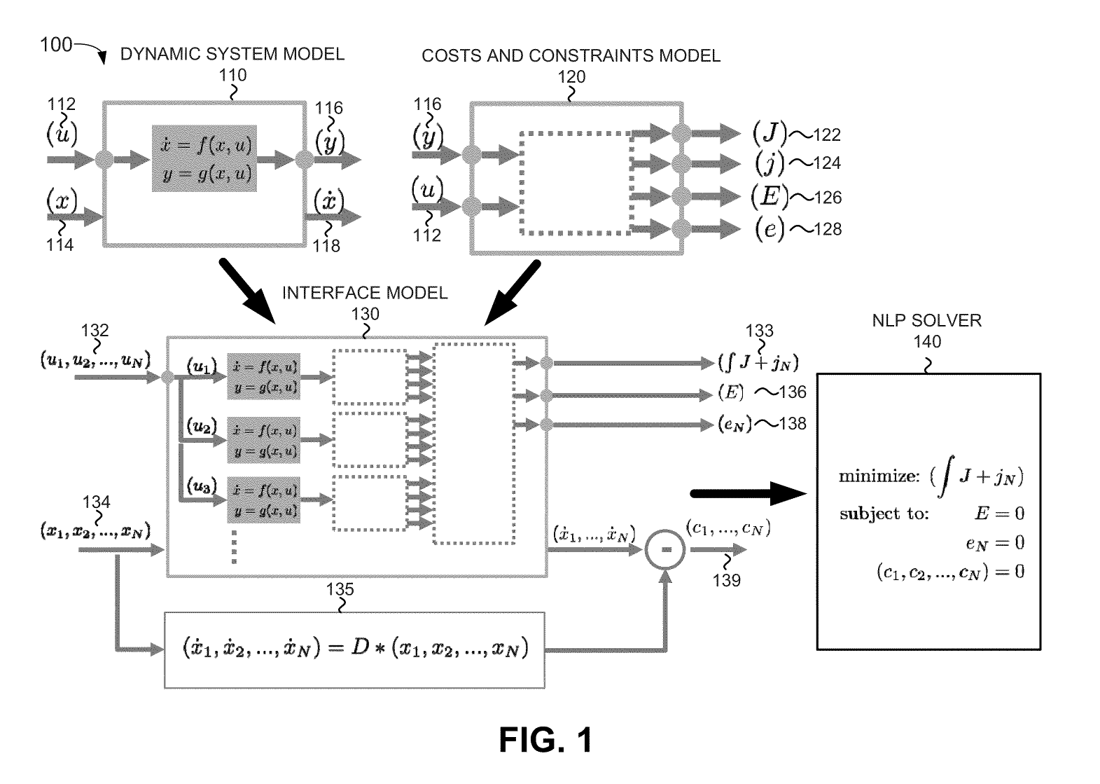

An implementation described herein relates to a framework for solving trajectory optimization problems using a modeling system. The modeling system may include a graphical modeling tool and/or application that provide a user interface for a numerical computing environment and/or for modeling and simulating a dynamic system. FIG. 1 is an overview diagram of a framework 100 for generating a solution to a trajectory optimization problem according to an implementation described herein. As shown in FIG. 1, framework 100 may include a dynamic system model 110, a costs and constraints model 120, an interface model 130, and a nonlinear programming solver (NLP) 140.

The framework may include functionality and user interfaces to enable a user to generate dynamic system model 110 and costs and constraints model 120. Dynamic system model 110 may define the dynamics (e.g., equations of motion) for one or more objects moving along a trajectory. Dynamic system model 110 may include a control vector input u 112 and a state vector input x 114, and may generate an output vector y 116 and a state derivative vector [symbol] 118 based on system equations:

[symbol]

=ƒ(x,u,t)

y=g(x,u,t) Equation (1)

In Equation (1), the function ƒ also called the derivative function, may characterize the rate of change of the state variables of the dynamic system as a function of the states, inputs, and time. The variables x, u, and y may be vectors. The function g, also called the output function, may characterize the outputs of the dynamic system as a function of the states, inputs, and time. Dynamic system model 110 may include multiple interconnected blocks, wherein each block may be characterized by Equation (1) with respect to the block's inputs and states.

Equation (1) for dynamic system model 110 may be generated based on the dynamic equations associated with each block and based on the interconnections between the blocks. A user may generate dynamic system model 110 using a modeling system by adding individual blocks to a modeling user interface and defining the interconnections between the blocks. The user may use pre-existing blocks and/or may generate a block by defining a derivative function and an output function for a block. Additionally or alternatively, a user may generate dynamic system model 110 by activating a user interface that enables a user to define a dynamic system for a trajectory optimization problem (e.g., by specifying particular equations of motion) and the modeling system may generate dynamic system model 110 based on the user's interaction with the user interface.

Costs and constraints model 120 may define the costs and/or constraints associated with the one or more objects moving along a trajectory, such as costs to be minimized (e.g., time, fuel, control effort, etc.), terminal constraints (e.g., starting position and/or velocity, ending position and/or velocity, etc.), path constraints (e.g., obstacles, dynamic loading, heating, control magnitude/direction, etc.). Costs and constraints model 120 may include control vector input u 112 and output vector y 116 as inputs and may generate one or more outputs. The outputs may include an integral cost output J 122, a terminal cost output j 124, a path constraints output E 126, and a terminal constraint output e 128. Integral cost output J 122 may include a sum of the costs over a particular trajectory based on costs and constraints model 120 and based on control vector input u 112 and output vector y 116. Terminal cost output j 124 may include the costs associated with the terminal constraints of the particular trajectory based on costs and constraints model 120 and based on control vector input u 112 and output vector y 116. Path constraints output E 126 may include the path constraints associated with the particular trajectory based on costs and constraints model 120 and based on control vector input u 112 and output vector v 116. Terminal constraint output e 128 may include the terminal constraints associated with the particular trajectory based on costs and constraints model 120 and based on control vector input u 112 and output vector y 116.

In some implementations, costs and constraints model 120 may include multiple interconnected blocks, wherein each block may be characterized by Equation (1) with respect to the block's inputs and states. Equation (1) for dynamic system model 120 may be generated based on the dynamic equations associated with each block and based on the interconnections between the blocks. A user may generate costs and constraints model 120 using a modeling system by adding individual blocks to a modeling user interface and defining the interconnections between the blocks. The user may use pre-existing blocks and/or may generate a block by defining a derivative function and an output function for a block. Additionally or alternatively, a user may generate costs and constraints model 120 by activating a user interface that enables a user to define a dynamic system for a trajectory optimization problem (e.g., by specifying particular equations of motion) and the modeling system may generate costs and constraints model 120 based on the user's interaction with the user interface.

In other implementations, costs and constraints model 120 may be defined by general logic functions that may not correspond to blocks characterized by a time-varying dynamic system. For example, a cost function may correspond to a positive semi-definite scalar function of a state and inputs of the function may include logical functions.

Framework 100 provided by the modeling system may automatically generate interface model 130 based on dynamic system model 110 and the costs and constraints model 120 generated by the user. Interface model 130 may include a vectorized form of dynamic system model 110 and cost and constraints model 120 joined together. Interface model 130 may be generated in the background and may not be visible to the user via a user interface. Framework 100 may enable the user to define one or more solution parameters for the trajectory optimization problem and interface model 130 may be expanded based on the defined solution parameters.

Trajectory optimization problems may be solved using indirect methods or using direct methods. Indirect methods may be based on the calculus of variations or on Pontryagin's minimum principle. Direct methods may be further divided into direct transcription methods and other types of methods, such as explicit Runge-Kutta integration methods and parallel shooting methods. Direct transcription methods, also known as collocation methods, may be used to convert an optimal control problem, which may be thought of as a nonlinear programming (NLP) problem with an infinite number of controls and constraints, into an NLP problem with a finite number of controls and constraints by discretizing the state and control variables. An NLP problem may involve solving a system of equalities and inequalities, representing constraints, over a set of variables, while minimizing or maximizing an objective function.

In a direct transcription method, a trajectory may be divided into discrete segments from an initial point to an end point, wherein the end points of each segment are referred to as nodes. Thus, each node may correspond to a particular time value in the time interval along which a trajectory is to be determined. The values of the states and the controls at each of the nodes may be treated as a set of NLP variables. The derivative functions may be approximated at each node using a selected approximation method. For example, for a segment from tₖ to tₖ₊₁:

x(tₖ₊₁)=x(tₖ)+∫ₜ_{ₖ}^{t}^{ₖ₊₁}ƒ(x(t),u(t))dt Equation (2)

where f(x(t), u(t)) corresponds to the derivative function associated with x(t). The integral in Equation (2) may be approximated using a selected approximation rule. As an example, using the trapezoidal rule, an approximation to Equation (2) may be written as:

$$x ( {t}_{k + 1} ) \approx x ( {t}_{k} ) + \frac{{t}_{k + 1} - {t}_{k}}{2} \cdot ( {f}_{k} + {f}_{k + 1} ) \qquad Equation ( 3 )$$

As another example, using Hermite-Simpson discretization, an approximation to Equation (2) may be written as:

$$x ( {t}_{k + 1} ) \approx x ( {t}_{k} ) + \frac{{t}_{k + 1} - {t}_{k}}{6} \cdot ( {f}_{k + 1} + 4 \cdot {f}_{{m}_{k}} + {f}_{k} ) \qquad Equation ( 4 )$$

wherein mₖ corresponds to the midpoint between tₖ and tₖ₊₁. Using a generalized implicit Runge-Kutta method, the approximation may be written as:

$$x ( {t}_{k + 1} ) \approx x ( {t}_{k} ) + {\sum }_{i = 1}^{s} {b}_{i} {k}_{i} , where \\ {k}_{i} = h \cdot f ( {t}_{k} + {c}_{i} \cdot h , {x}_{k} + {\sum }_{j = 1}^{s} {a}_{ij} {k}_{j} ) \qquad Equation ( 5 )$$

where h corresponds to the step size tₖ₊₁-tₖ and where aᵢⱼ, bᵢ, and cᵢ correspond to the coefficients of the Butcher tableau of order s. The differences between the analytical solution and the approximation, referred to as defects, may be written as:

$${Δ}_{k} = x ( {t}_{k + 1} ) - x ( {t}_{k} ) - {\sum }_{i = 1}^{s} {b}_{i} {k}_{i} \qquad Equation ( 6 )$$

Since the dynamic equations for dynamic system model 110 are satisfied when the defects approach zero, a set of defect constraints may be defined for the NLP problem. The defect constraints may require that the defects approach zero and are enforced, together with other constraints defined by costs and constraints model 120, at the nodes for the variables of the NLP problem. As an example, for a trapezoidal rule approximation, the nodes may include the end points of the segments as well as the start and end points of the trajectory. The variables for the NLP problem may include the state vector x and control input vector u at each node, the start and end points, as well as any time-independent parameters associated with dynamic system model 110. As another example, for a Hermite-Simpson discretization, the nodes may additionally include the midpoints of the segments and the variables for the NLP problem may additionally include the state vector x and the control input vector u at the midpoints.

Returning to FIG. 1, interface model 130 may be used to generate an NLP problem corresponding to the trajectory optimization problem defined by dynamic system model 110 and the costs and constraints model 120. The user may be provided with a user interface that may enable the user to select solution parameters for the NLP problem. For example, the user may select an approximation method, a number of nodes, upper and/or lower bounds for the solution, an initial guess for the solution, and/or may select other solution parameters. Based on the solution parameters, interface model 130 may be expanded.

Interface model 130 may include a set of control vector inputs u₁, . . . u_{N} 132 and a set of state vector inputs x₁, . . . x_{N} 134, based on the number of nodes N associated with expanded interface model 130. Expanded interface model 130 may include an approximation subsystem block 135, which may determine approximated derivatives of the state vectors using a matrix of coefficients D. The matrix of coefficients D may include a constant matrix whose values are derived based on the number of nodes and the method of discretization chosen (e.g., based on a Butcher tableau associated with a chosen approximation method). Interface model 130 may include a total cost output 133, a path constraints output 136, a terminal constraints output 138, and a defects output 139.

Interface model 130 may be evaluated using an NLP solver 140. For example, an interface model function may be generated based on expanded interface model 130. A solution function may be generated that includes a first function expression, using the interface model function, to determine a set of outputs, and that includes a second function expression, using the interface model function, to determine a set of state derivatives. The solution function may be minimized based on an initial guess solution and/or specified bounds to generate a solution to the trajectory optimization problem to minimize the total cost while satisfying the path constraints, the terminal constraints, and the defect constraints.

A user interface may be generated that may present the generated results to the user. The user interface may include interactive elements that may enable the user to modify the solution. For example, the user may be provided with an option to calculate neighboring optimal control (NOC) gains based on the generated solution. The generated solution may be referred to as a nominal optimal control solution, or as an open loop optimal control solution. The reason the solution may be referred to as an open loop optimal control solution is that if the dynamic system is represented as a plant and controller system, no feedback loop will exist from the output to the control input. Thus, control input vector u 112 may not be modified based on output vector y 116.

The user may desire to approximate the solution when parameters associated with dynamic system are perturbed. NOC gains may correspond to gains that may be applied to control input vector u 112 in response to a perturbation in the state variables. The NOC gains may be computed by perturbing, in sequence, each state variable associated with the trajectory optimization problem and re-calculating a nominal optimal control solution for each perturbed state variable. The re-calculated solutions may be differences with the nominal optimal control solution to obtain the NOC gains. Thus, if x*(t) and u*(t) correspond to the control input vector and state vector associated with the nominal optimal control solution, and xₚ(t) and uₚ(t) correspond to the perturbed control input vector and state vector, the NOC gains may be computed by solving for K(t):

δx(t)=xₚ(t)−x*(t)

δu(t)=uₚ(t)−u*(t)

δu(t)=K(t)δx(t)

The user may be provided with an option to generate a controller block that includes the determined NOC gains. The controller block may be added to dynamic system model 110 with a feedback loop to control input vector u 112. Thus, the NOC gains may be used to generate a closed loop solution to the trajectory optimization problem. The modeling system may generate a user interface that includes the closed loop solution and may include an interaction object that enables the user to perturb the system and view the change in the optimized trajectory based on the perturbation. The NOC solution may represent a feedback control solution based on a nominal optimal trajectory determined to be optimal to second order. If perturbations from the nominal optimal state trajectory are small, the NOC solution may be optimal to second order.

Although FIG. 1 shows exemplary components of framework 100, in other implementations, framework 100 may include fewer components, different components, differently arranged components, and/or additional components than those depicted in FIG. 1. Alternatively, or additionally, one or more components of framework 100 may perform one or more tasks described as being performed by one or more other components of framework 100.

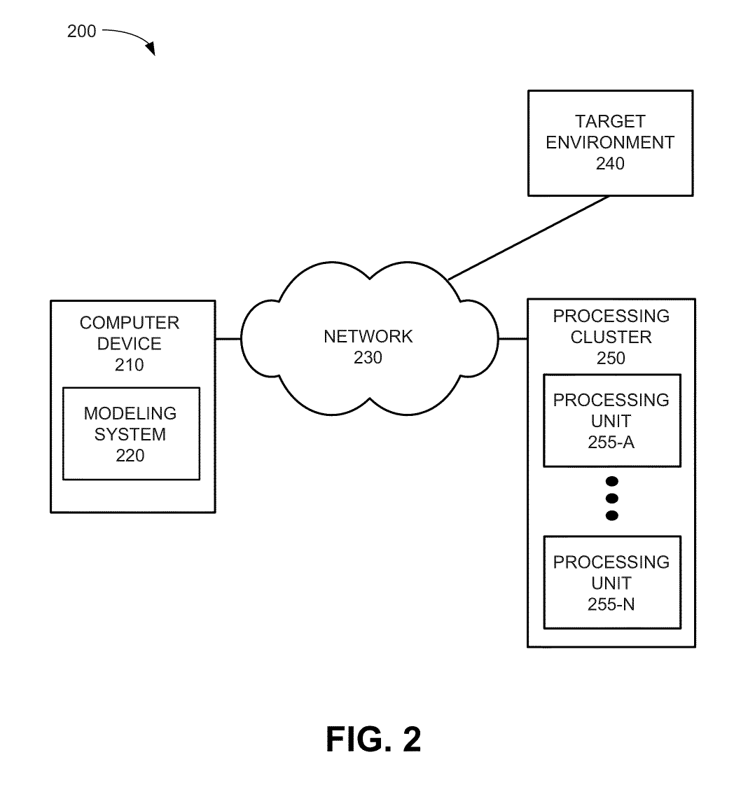

FIG. 2 is a diagram of an exemplary environment 200 for implementing framework 100 according to an implementation described herein. As shown in FIG. 2, environment 200 may include a computer device 210, a network 230, a target environment 240, and a processing cluster 250.

Computer device 210 may include one or more computer devices, such as a personal computer, a workstation, a server device, a blade server, a mainframe, a personal digital assistant (PDA), a laptop, a tablet, or another type of computation or communication device. Computer device 210 may include a modeling system 220. Modeling system 220 may include a development tool (e.g., a software application) that enables creation, modification, design, and/or simulation of graphical models representing dynamic systems. Furthermore, modeling system 220 may enable the automatic generation of executable code based on a graphical model. Modeling system 220 may include functionality for providing framework 100 for solving trajectory optimization problems defined by a dynamics model and a costs and constraints model.

Network 230 may enable computer device 210 to communicate with other components of environment 200, such as target environment 240 and/or processing cluster 250. Network 220 may include one or more wired and/or wireless networks. For example, network 220 may include a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a Wi-Fi network, an Ethernet network, a combination of the above networks, and/or another type of wireless network. Additionally, or alternatively, network 230 may include a local area network (LAN), a wide area network (WAN), a metropolitan area network (MAN), an ad hoc network, an intranet, the Internet, a fiber optic-based network (e.g., a fiber optic service network), a satellite network, a television network, and/or a combination of these or other types of networks.

Target environment 240 may include one or more devices that may be associated with a dynamic system that is represented by a graphical model in modeling system 220. For example, target environment 240 may include a set of sensors and/or a set of controllers corresponding to a dynamic system. Modeling system 220 may receive data from target environment 240 and use the received data as input to the graphical model. Furthermore, target environment 240 may receive executable code from modeling system 220. The received executable code may enable target environment 240 to perform one or more operations on the dynamic system associated with target environment 240. Target environment 240 may include, for example, an embedded processing device.

Processing cluster 250 may include processing resources which may be used by modeling system 220 in connection with a graphical model. For example, processing cluster 250 may include processing units 255-A to 255-N (referred to herein collectively as “processing units 255” and individually as “processing unit 255”). Processing units 255 may perform operations on behalf of computer device 210. For example, processing units 255 may perform parallel processing in a graphical model in modeling system 220. Modeling system 220 may provide an operation to be performed to processing cluster 250, processing cluster 250 may divide tasks associated with the operation among processing units 255, processing cluster 250 may receive results of the performed tasks from processing units 255, and may generate a result of the operation and provide the result of the operation to modeling system 220.

In one implementation, processing unit 255 may include a graphic processing unit (GPU). A GPU may include one or more devices that include specialized circuits for performing operations relating to graphics processing (e.g., block image transfer operations, simultaneous per-pixel operations, etc.) and/or for performing a large number of operations in parallel. In another example, processing unit 255 may correspond to a single core of a multi-core processor. In yet another example, processing unit 255 may include a computer device that is part of a cluster of computer devices, e.g., computing devices operating as part of a computing cloud.

Although FIG. 2 shows exemplary components of environment 200, in other implementations, environment 200 may include fewer components, different components, differently arranged components, and/or additional components than those depicted in FIG. 2. Alternatively, or additionally, one or more components of environment 200 may perform one or more tasks described as being performed by one or more other components of environment 200.

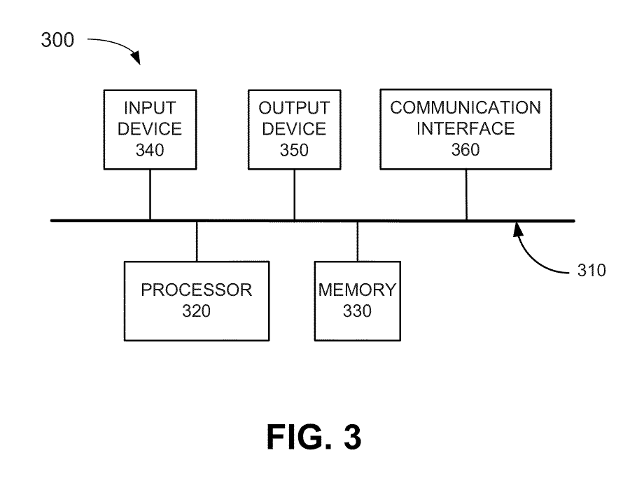

FIG. 3 is a diagram illustrating exemplary components of computer device 210 according to a first implementation described herein. As shown in FIG. 3, computer device 210 may include a bus 310, a processor 320, a memory 330, an input device 340, an output device 350, and a communication interface 360.

Bus 310 may include a path that permits communication among the components of computer device 300. Processor 320 may include one or more single-core and/or or multi-core processors, microprocessors, and/or processing logic (e.g., application specific integrated circuits (ASICs), field programmable gate arrays (FPGAs), ARM processors, etc.) that may interpret and execute instructions. Memory 330 may include a random access memory (RAM) device or another type of dynamic storage device that may store information and instructions for execution by processor 320, a read only memory (ROM) device or another type of static storage device that may store static information and instructions for use by processor 320, a magnetic and/or optical recording memory device and its corresponding drive, and/or a removable form of memory, such as a flash memory.

Input device 340 may include a mechanism that permits an operator to input information to computer device 210, such as a keypad, a keyboard, a button, or an input jack for an input device such as a keypad or a keyboard, a camera, an analog to digital (ADC) converter, a pulse-width modulation (PWM) input, etc. Output device 350 may include a mechanism that outputs information to the operator, including one or more light indicators, a display, a speaker, a digital to analog (DAC) converter, a PWM output, etc.

Communication interface 360 may include a transceiver that enables computer device 210 to communicate with other devices and/or systems. For example, communication interface 360 may include a modem, a network interface card, and/or a wireless interface card.

As will be described in detail below, computer device 210 may perform certain operations relating to a framework for generating a solution to a trajectory optimization problem. Computer device 210 may perform these operations in response to processor 320 executing software instructions stored in a computer-readable medium, such as memory 330. A computer-readable medium may be defined as a non-transitory memory device. A memory device may include memory space within a single physical memory device or spread across multiple physical memory devices.

The software instructions may be read into memory 330 from another computer-readable medium, or from another device via communication interface 360. The software instructions contained in memory 330 may cause processor 320 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows exemplary components of computer device 210, in other implementations, computer device 210 may include fewer components, different components, additional components, or differently arranged components than depicted in FIG. 3. Additionally or alternatively, one or more components of computer device 210 may perform one or more tasks described as being performed by one or more other components of computer device 300.

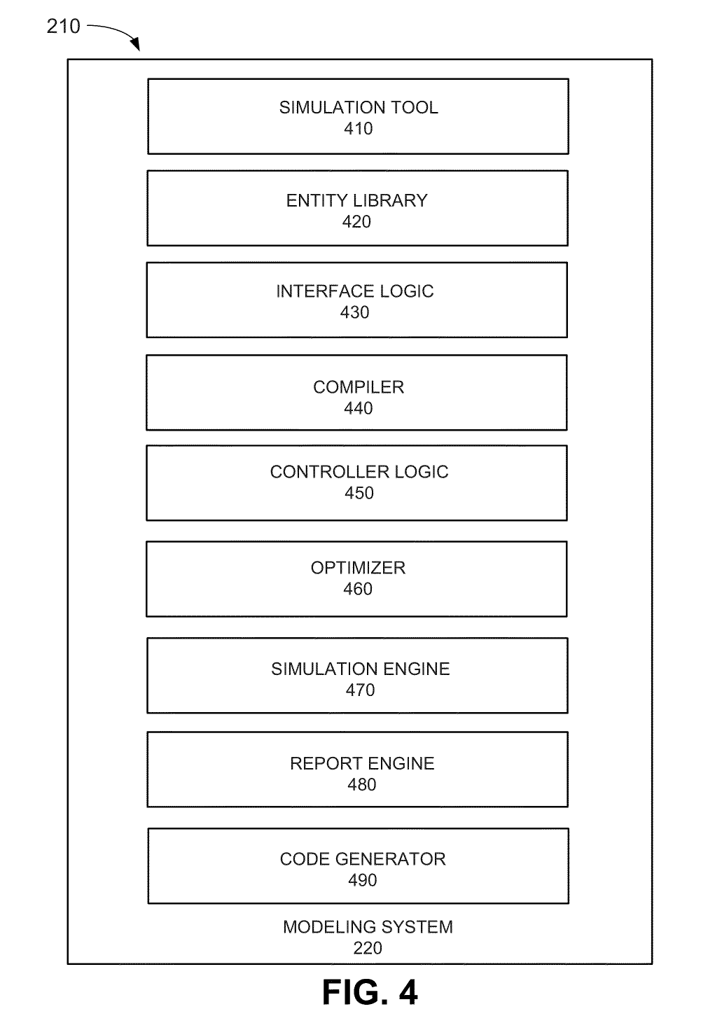

FIG. 4 is a diagram of exemplary components of modeling system 220 that may be included in computer device 210. Modeling system 220 may include a development tool that enables existing software components to be used in the creation of a model and that may enable generation of executable code based on the model. For example, the development tool may include a graphical modeling tool or application that provides a user interface for a numerical computing environment. Additionally, or alternatively, the development tool may include a graphical modeling tool and/or application that provides a user interface for modeling and simulating (e.g., by executing a model) a dynamic system (e.g., based on differential equations, difference equations, algebraic equations, discrete events, discrete states, stochastic relations, etc.).

A dynamic system (either natural or man-made) may be a system whose response at any given time may be a function of its input stimuli, its current state, and a current time. Such systems may range from simple to highly complex systems. Natural dynamic systems may include, for example, a falling body, the rotation of the earth, bio-mechanical systems (muscles, joints, etc.), bio-chemical systems (gene expression, protein pathways), weather, and climate pattern systems, and/or any other natural dynamic system. Man-made or engineered dynamic systems may include, for example, a bouncing ball, a spring with a mass tied on an end, automobiles, aircrafts, control systems in major appliances, communication networks, audio signal processing systems, and a financial or stock market, and/or any other man-made or engineered dynamic system.

The system represented by a model may have various execution semantics that may be represented in the model as a collection of modeling entities, often referred to as blocks. A block may generally refer to a portion of functionality that may be used in the model. The block may be represented graphically, textually, and/or stored in some form of internal representation. Also, a particular visual depiction used to represent the block, for example in a graphical block diagram, may be a design choice.

A block may be hierarchical in that the block itself may comprise one or more blocks that make up the block. A block comprising one or more blocks (sub-blocks) may be referred to as a subsystem block. A subsystem block may be configured to represent a subsystem of the overall system represented by the model. A subsystem block may be a masked subsystem block that is configured to have a logical workspace that contains variables only readable and writeable by elements contained by the subsystem block.

A graphical model (e.g., a functional model) may include entities with relationships between the entities, and the relationships and/or the entities may have attributes associated with them. The entities my include model elements, such as blocks and/or ports. The relationships may include model elements, such as lines (e.g., connector lines) and references. The attributes may include model elements, such as value information and meta information for the model element associated with the attributes. A graphical model may be associated with configuration information. The configuration information may include information for the graphical model, such as model execution information (e.g., numerical integration schemes, fundamental execution period, etc.), model diagnostic information (e.g., whether an algebraic loop should be considered an error or result in a warning), model optimization information (e.g., whether model elements should share memory during execution), model processing information (e.g., whether common functionality should be shared in code that is generated for a model), etc.

Additionally, or alternatively, a graphical model may have executable semantics and/or may be executable. An executable graphical model may be a time based block diagram. A time based block diagram may consist, for example, of blocks connected by lines (e.g., connector lines). The blocks may consist of elemental dynamic systems such as a differential equation system (e.g., to specify continuous-time behavior), a difference equation system (e.g., to specify discrete-time behavior), an algebraic equation system (e.g., to specify constraints), a state transition system (e.g., to specify finite state machine behavior), an event based system (e.g., to specify discrete event behavior), etc. The lines may represent signals (e.g., to specify input/output relations between blocks or to specify execution dependencies between blocks), variables (e.g., to specify information shared between blocks), physical connections (e.g., to specify electrical wires, pipes with volume flow, rigid mechanical connections, etc.), etc. The attributes may consist of meta information such as sample times, dimensions, complexity (whether there is an imaginary component to a value), data type, etc. associated with the model elements.

In a time based block diagram, ports may be associated with blocks. A relationship between two ports may be created by connecting a line (e.g., a connector line) between the two ports. Lines may also, or alternatively, be connected to other lines, for example by creating branch points. For instance, three or more ports can be connected by connecting a line to each of the ports, and by connecting each of the lines to a common branch point for all of the lines. A common branch point for the lines that represent physical connections may be a dynamic system (e.g., by summing all variables of a certain type to 0 or by equating all variables of a certain type). A port may be an input port, an output port, an enable port, a trigger port, a function-call port, a publish port, a subscribe port, an exception port, an error port, a physics port, an entity flow port, a data flow port, a control flow port, etc.

Relationships between blocks may be causal and/or non-causal. For example, a model (e.g., a functional model) may include a block that represents a continuous-time integration block that may be causally related to a data logging block by using a line (e.g., a connector line) to connect an output port of the continuous-time integration block to an input port of the data logging block. Further, during execution of the model, the value stored by the continuous-time integrator may change as the current time of the execution progresses. The value of the state of the continuous-time integrator may be available on the output port and the connection with the input port of the data logging block may make this value available to the data logging block.

In one example, a block may include or otherwise correspond to a non-causal modeling function or operation. An example of a non-causal modeling function may include a function, operation, or equation that may be executed in different fashions depending on one or more inputs, circumstances, and/or conditions. Put another way, a non-causal modeling function or operation may include a function, operation, or equation that does not have a predetermined causality. For instance, a non-causal modeling function may include an equation (e.g., X=2Y) that can be used to identify the value of one variable in the equation (e.g., “X”) upon receiving an assigned value corresponding to the other variable (e.g., “Y”). Similarly, if the value of the other variable (e.g., “Y”) were provided, the equation could also be used to determine the value of the one variable (e.g., “X”).

Assigning causality to equations may consist of determining which variable in an equation is computed by using that equation. Assigning causality may be performed by sorting algorithms, such as a Gaussian elimination algorithm. The result of assigning causality may be a lower block triangular matrix that represents the sorted equations with strongly connected components representative of algebraic cycles or loops. Assigning causality may be part of model compilation.

Equations may be provided in symbolic form. A set of symbolic equations may be symbolically processed to, for example, produce a simpler form. To illustrate, a system of two equations X=2Y+U and Y=3X−2U may be symbolically processed into one equation 5Y=−U. Symbolic processing of equations may be part of model compilation.

As such, a non-causal modeling function may not, for example, require a certain input or type of input (e.g., the value of a particular variable) in order to produce a valid output or otherwise operate as intended. Indeed, the operation of a non-causal modeling function may vary based on, for example, circumstance, conditions, or inputs corresponding to the non-causal modeling function. Consequently, while the description provided above generally describes a directionally consistent signal flow between blocks, in other implementations, the interactions between blocks may not necessarily be directionally specific or consistent.

In an embodiment, connector lines in a model may represent related variables that are shared between two connected blocks. The variables may be related such that their combination may represent power. For example, connector lines may represent voltage, and current, power, etc. Additionally, or alternatively, the signal flow between blocks may be automatically derived.

In some implementations, one or more blocks may also, or alternatively, operate in accordance with one or more rules or policies corresponding to a model in which they are included. For instance, if the model were intended to behave as an actual, physical system or device, such as an electronic circuit, the blocks may be required to operate within, for example, the laws of physics (also referred to herein as “physics-based rules”). These laws of physics may be formulated as differential and/or algebraic equations (e.g., constraints, etc.). The differential equations may include derivatives with respect to time, distance, and/or other quantities, and may be ordinary differential equations (ODEs), partial differential equations (PDEs), and/or differential and algebraic equations (DAEs). Requiring models and/or model components to operate in accordance with such rules or policies may, for example, help ensure that simulations based on such models will operate as intended.

A sample time may be associated with the elements of a graphical model. For example, a graphical model may include a block with a continuous sample time such as a continuous-time integration block that may integrate an input value as time of execution progresses. This integration may be specified by a differential equation. During execution, the continuous-time behavior may be approximated by a numerical integration scheme that is part of a numerical solver. The numerical solver may take discrete steps to advance the execution time, and these discrete steps may be constant during an execution (e.g., fixed step integration) or may be variable during an execution (e.g., variable-step integration).

Alternatively, or additionally, a graphical model may include a block with a discrete sample time such as a unit delay block that may output values of a corresponding input after a specific delay. This delay may be a time interval and this interval may determine a sample time of the block. During execution, the unit delay block may be evaluated each time the execution time has reached a point in time where an output of the unit delay block may change. These points in time may be statically determined based on a scheduling analysis of the graphical model before starting execution.

Alternatively, or additionally, a graphical model may include a block with an asynchronous sample time, such as a function-call generator block that may schedule a connected block to be evaluated at a non-periodic time. During execution, a function-call generator block may evaluate an input and when the input attains a specific value when the execution time has reached a point in time, the function-call generator block may schedule a connected block to be evaluated at this point in time and before advancing execution time.

Further, the values of attributes of a graphical model may be inferred from other elements of the graphical model or attributes of the graphical model. The inferring may be part of a model compilation. For example, the graphical model may include a block, such as a unit delay block, that may have an attribute that specifies a sample time of the block. When a graphical model has an execution attribute that specifies a fundamental execution period, the sample time of the unit delay block may be inferred from this fundamental execution period.

As another example, the graphical model may include two unit delay blocks where the output of the first of the two unit delay blocks is connected to the input of the second of the two unit delay block. The sample time of the first unit delay block may be inferred from the sample time of the second unit delay block. This inference may be performed by propagation of model element attributes such that after evaluating the sample time attribute of the second unit delay block, a graph search proceeds by evaluating the sample time attribute of the first unit delay block since it is directly connected to the second unit delay block.

The values of attributes of a graphical model may be set to characteristic settings, such as one or more inherited settings, one or more default settings, etc. For example, the data type of a variable that is associated with a block may be set to a default such as a double. Because of the default setting, an alternate data type (e.g., a single, an integer, a fixed point, etc.) may be inferred based on attributes of elements that the graphical model comprises (e.g., the data type of a variable associated with a connected block) and/or attributes of the graphical model. As another example, the sample time of a block may be set to be inherited. In case of an inherited sample time, a specific sample time may be inferred based on attributes of elements that the graphical model comprises and/or attributes of the graphical model (e.g., a fundamental execution period).

Modeling system 220 may implement a technical computing environment (TCE). A TCE may include hardware and/or software based logic that provides a computing environment that allows users to perform tasks related to disciplines, such as, but not limited to, mathematics, science, engineering, medicine, business, etc., more efficiently than if the tasks were performed in another type of computing environment, such as an environment that required the user to develop code in a conventional programming language, such as C++, C, Fortran, Java, etc.

In one implementation, the TCE may include a dynamically typed language that can be used to express problems and/or solutions in mathematical notations familiar to those of skill in the relevant arts. For example, the TCE may use an array as a basic element, where the array may not require dimensioning. In addition, the TCE may be adapted to perform matrix and/or vector formulations that can be used for data analysis, data visualization, application development, simulation, modeling, algorithm development, etc. These matrix and/or vector formulations may be used in many areas, such as statistics, image processing, signal processing, control design, life sciences modeling, discrete event analysis and/or design, state based analysis and/or design, etc.

The TCE may further provide mathematical functions and/or graphical tools (e.g., for creating plots, surfaces, images, volumetric representations, etc.). In one implementation, the TCE may provide these functions and/or tools using toolboxes (e.g., toolboxes for signal processing, image processing, data plotting, parallel processing, etc.). In another implementation, the TCE may provide these functions as block sets. In still another implementation, the TCE may provide these functions in another way, such as via a library, etc. The TCE may be implemented as a text based environment, a graphically based environment, or another type of environment, such as a hybrid environment that is both text and graphically based.

The TCE may be implemented using products such as, but not limited to, MATLAB® by The MathWorks, Inc.; Octave; Python; Comsol Script; MATRIXx from National Instruments; Mathematica from Wolfram Research, Inc.; Mathcad from Mathsoft Engineering & Education Inc.; Maple from Maplesoft Extend from Imagine That Inc.; Scilab from The French Institution for Research in Computer Science and Control (INRIA); Virtuoso from Cadence; or Modelica or Dymola from Dassault Systemes.

An alternative embodiment may implement a TCE in a graphically-based TCE using products such as, but not limited to, Simulink®, Stateflow®, SimEvents, etc., by The MathWorks, Inc.; VisSim by Visual Solutions; LabView® by National Instruments; Dymola by Dassault Systemes; SoftWIRE by Measurement Computing; WiT by DALSA Coreco; VEE Pro or SystemVue by Agilent; Vision Program Manager from PPT Vision; Khoros from Khoral Research; Gedae by Gedae, Inc.; Scicos from (INRIA); Virtuoso from Cadence; Rational Rose from IBM; Rhopsody or Tau from Telelogic; Ptolemy from the University of California at Berkeley; or aspects of a Unified Modeling Language (UML) or SysML environment.

A further alternative embodiment may be implemented in a language that is compatible with a product that includes a TCE, such as one or more of the above identified text-based or graphically-based TCEs. For example, MATLAB (a text-based TCE) may use a first command to represent an array of data and a second command to transpose the array. Another product, that may or may not include a TCE, may be MATLAB-compatible and may be able to use the array command, the array transpose command, or other MATLAB commands. For example, the other product may use the MATLAB commands to perform model checking.

Yet another alternative embodiment may be implemented in a hybrid TCE that combines features of a text-based and graphically-based TCE. In one implementation, one TCE may operate on top of the other TCE. For example, a text-based TCE (e.g., MATLAB) may operate as a foundation and a graphically-based TCE (e.g., Simulink) may operate on top of MATLAB and may take advantage of text-based features (e.g., commands) to provide a user with a graphical user interface and graphical outputs (e.g., graphical displays for data, dashboards, etc.).

As shown in FIG. 4, modeling system 220 may include a simulation tool 410, an entity library 420, an interface logic 430, a compiler 440, a controller logic 450, an optimizer 460, a simulation engine 470, a report engine 480, and a code generator 490.

Simulation tool 410 may include an application for building a model. Simulation tool 410 may be used to build a textual model or a graphical model having executable semantics, such as dynamic system model 110 and/or costs and constraints model 120. In the case of graphical models, simulation tool 410 may allow users to create, display, modify, diagnose, annotate, delete, print, etc., model entities and/or connections. Simulation tool 410 may interact with other entities illustrated in FIG. 2 for receiving user inputs, executing a model to obtain a simulation, displaying results, generating code, etc. Simulation tool 410 may provide a user with an editor for constructing or interacting with textual models and/or a GUI for creating or interacting with graphical models. The editor may be configured to allow a user to, for example, specify, edit, annotate, save, print, and/or publish a model. A textual interface may be provided to permit interaction with the editor. A user may write scripts that perform automatic editing operations on a model using the textual interface. For example, the textual interface may provide a set of windows that may act as a canvas for the model, and may permit user interaction with the model. A model may include one or more windows. A model that is partitioned into multiple hierarchical levels may show different hierarchical levels in separate windows.

Entity library 420 may include code modules or entities (e.g., blocks/icons) that a user can drag and drop into a display window that includes a graphical model, such as particular blocks added to dynamic system model 110 and/or costs and constraints model 120. In the case of graphical models, a user may further couple entities using connections to produce a graphical model of a system, such as target environment 140.

Interface logic 430 may allow modeling system 220 to send or receive data and/or information to/from devices (e.g., target environment 240, processing cluster 250, etc.) or software modules (e.g., a function, an application program interface, etc.).

Compiler 440 may compile a model, such as dynamic system model 110, costs and constraints model 120, and/or interface model 130, into an executable format. Code generator 490 may generate code from compiled model produced by compiler 440. The generated code may be executed on computer device 210 to produce a modeling result. In an embodiment, compiler 440 may also provide debugging capabilities for diagnosing errors associated with the model. Code generator 490 may generate executable code for a part of a graphical model. The executable code may then be automatically executed during execution of the model, so that a first part of the model executes as an interpreted execution and a second part of the model executes as a compiled execution.

Controller logic 450 may be used to create and implement controllers in a graphical model. For example, controller logic 450 may provide functionality for entities that represent types of controllers in the graphical model. When the graphical model executes, controller logic 450 may perform control operations on the model by interacting with entities in the graphical model. In an embodiment, controller logic 450 may include control algorithms that implement controllers in the graphical model, such as, for example, feedback control that includes the determined NOC gains associated with framework 100, ‘proportional-integral-derivative’ (PID) controls, gain scheduling controls, H-infinity controls, model predictive controls (MPC), dynamic inversion controls, bang/bang controls, sliding mode controls, deadbeat controls, and/or other another type of controls. Embodiments of controller logic 450 may be configured to operate in standalone or distributed implementations.

Optimizer 460 may optimize code, parameters, performance (e.g., execution speed, memory usage), etc., for a model. For example, optimizer 460 may optimize code to cause the code to occupy less memory, to cause the code to execute more efficiently, to cause the code to execute faster, etc., than the code would execute if the code were not optimized. Optimizer 460 may also perform optimizations for controller logic 450, e.g., to optimize parameters for a controller. In an embodiment, optimizer 460 may operate with or may be integrated into compiler 440, controller logic 450, code generator 490, etc. Embodiments of optimizer 460 may be implemented via software objects that interact with other object oriented software, e.g., for receiving data on which optimizer 460 operates.

Simulation engine 470 may perform operations for executing a model to simulate a system. Executing a model to simulate a system may be referred to as simulating a model. Simulation engine 470 may be configured to perform standalone or remote simulations based on user preferences or system preferences.

Report engine 480 may produce a report based on information in modeling system 220. For example, report engine 480 may produce a report indicating whether a controller satisfies design specifications, a report indicating whether a controller operates in a stable manner, a report indicating whether a model compiles properly, etc. Embodiments of report engine 480 can produce reports in an electronic format for display on output device 350, in a hardcopy format, and/or a format adapted for storage in a storage device.

Code generator 490 can generate code from a compiled model produced by compiler 440. In an embodiment, code generator 490 may be configured to compile and link the generated code to produce an “in-memory executable” version of a model. The in-memory executable version of model may be used, for example, to simulate, verify, trim, and/or linearize the model. In an embodiment, code generator 490 may receive code in a first format and may transform the code from the first format into a second format. In an embodiment, code generator 490 can generate source code, assembly language code, binary code, interface information, configuration information, performance information, task information, etc., from at least a portion of a model. For example, code generator 490 can generate C, C++, SystemC, Java, Structured Text, hardware description language (HDL), etc., code from the model.

Embodiments of code generator 490 can further generate Unified Modeling Language (UML) based representations and/or extensions from some or all of a graphical model (e.g., System Modeling Language (SysML), Extensible Markup Language (XML), Modeling and Analysis of Real Time and Embedded Systems (MARTE), Architecture Analysis and Design Language (AADL), Hardware Description Language (HDL), Automotive Open System Architecture (AUTOSAR), etc.). In an embodiment, optimizer 460 can interact with code generator 490 to generate code that is optimized according to a parameter (e.g., memory use, execution speed, multi-processing, etc.). Embodiments of modeling environments consistent with principles of the invention can further include components such as verification components, validation components, etc.

Although FIG. 4 shows exemplary components of modeling system 220, in other implementations, modeling system 220 may include fewer components, different components, differently arranged components, or additional components than depicted in FIG. 4. Additionally or alternatively, one or more components of modeling system 220 may perform one or more tasks described as being performed by one or more other components of modeling system 220.

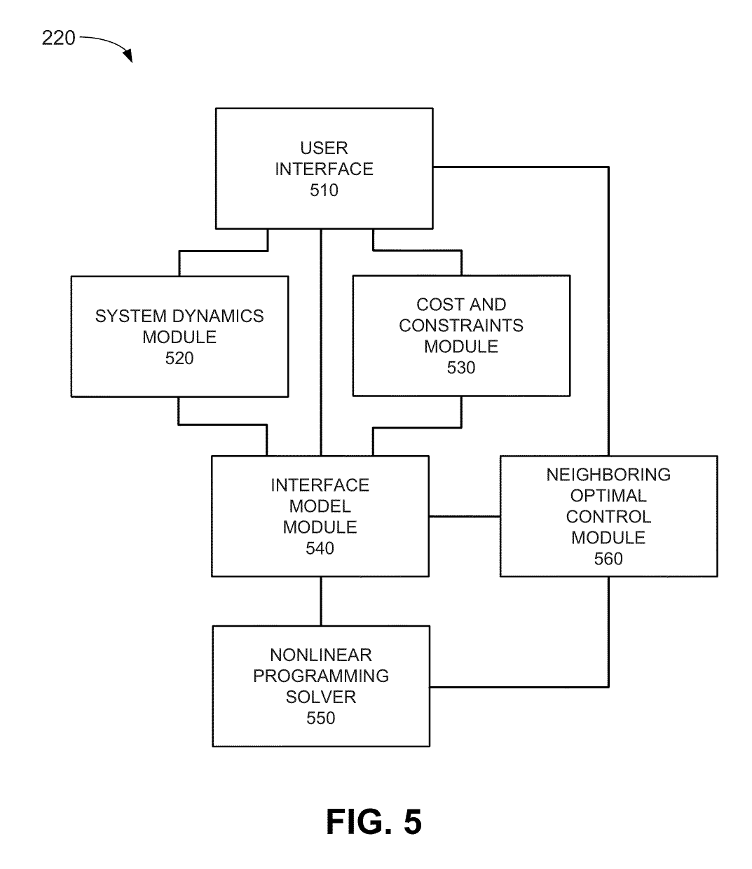

FIG. 5 is a diagram of exemplary functional components of modeling system 220 that relate to a framework for generating a solution to a trajectory optimization problem. The functional components of modeling system 220 shown in FIG. 5 may be implemented, for example, as part of simulation tool 410, entity library 420, and/or any of the other components of modeling system 220 described above in connection with FIG. 4. Furthermore, the functional components of modeling system 220 shown in FIG. 5 may be implemented by processor 320 and memory 330 of computer device 210. Additionally or alternatively, some or all of the functional components of modeling system 220 shown in FIG. 5 may be implemented by hard-wired circuitry. As shown in FIG. 5, modeling system 220 may include a user interface 510, a system dynamics module 520, a cost and constraints module 530, an interface model module 540, a nonlinear programming solver 550, and a neighboring optimal control module 560.

User interface 510 may generate one or more user interfaces that may enable a user to configure dynamic system model 110 and/or to configure costs and constraints model 120. For example, user interface 510 may enable a user to identify input and output ports of an existing model to define dynamic system model 110, may enable a user to import a model to define dynamic system model 110 and/or costs and constraints model 120, may generate a skeleton model and may guide the user to modify the skeleton model to define costs and constraints model 120, may provide a user interface to enable a user to define the dynamics for dynamics system model 110 and may generate dynamics system model 110 based on the defined dynamics, may provide a user interface to enable a user to define costs and constraints for costs and constraints model 120 and may generate costs and constraints model 110 based on the defined costs and constraints, and/or may enable the user to configure dynamic system model 110 and/or to configure costs and constraints model 120 using another method.

Furthermore, user interface 510 may generate a user interface to enable the user to define one or more solution parameters for generating a solution to a trajectory optimization problem defined by dynamic system model 110 and costs and constraints model 120. The one or more solution parameters may be used to expand interface model 130 based on, for example, the number of nodes selected by the user. Moreover, user interface 510 may generate a user interface that provides to a solution to a trajectory optimization problem to the user (e.g., a graph that plots an optimum trajectory). Furthermore, user interface 510 may enable a user to select to compute NOC gains based on the provided solution.

System dynamics module 520 may generate and/or configure dynamic system model 110 based on selections made by a user via user interface 510. For example, if a user enters an equation to define the dynamics of a system via user interface 510, system dynamics module 520 may generate dynamic system model 110 based on the equation.

Cost and constraints module 530 may generate costs and constraints model 120 based on selections made by the user via user interface 510. For example, if a user enters terminal constraints, path constraints, and/or a cost equation via user interface 510, cost and constraints module 530 may generate costs and constraints model 120 based on the terminal constraints, path constraints, and cost equation.

Interface model module 540 may generate interface model 130 based on dynamic system model 110 and based on costs and constraints model 120. For example, interface model module 540 may generate interface model 130 by combining dynamic system model 110 with costs and constraints model 120 such that control vector input u 112 functions as an input to both dynamic system model 110 and costs and constraints model 120 and output vector y 116 of dynamic system model 110 functions as an input to costs and constraints model 120. Furthermore, interface model module 540 may expand interface model 130 based on solution parameters selected by the user. For example, interface model module 540 may generate an instance of dynamic system model 110 and costs and constraints model 120 for each node of the nonlinear programming problem corresponding to the trajectory optimization model. The expanded interface model 130 may include as outputs a first state derivatives vector, an integral cost output, a terminal cost output, a path constraints output, and a terminal constraints output. Interface model module 540 may further generate a matrix of coefficients to determine a second state derivatives vector based on state vector input x 114 and may difference the second state derivatives vector with the first state derivatives vector to obtain a defects vector.

Nonlinear programming solver 550 may solve a nonlinear programming problem defined by an expanded interface model 130. For example, nonlinear programming solver 550 may generate an interface model function in a programming language based on expanded interface model 130 to generate an output vector and a state derivatives vector. The generated function may be minimized based on an initial guess solution and/or specified bounds to generate a solution to the trajectory optimization problem to minimize the total cost while satisfying the path constraints, the terminal constraints, and the defect constraints. A solution determined by nonlinear programming solver 550 may be provided to the user via user interface 510.

Neighboring optimal control module 560 may generate NOC gains for a trajectory optimization problem defined by interface model 130 based on a solution generated by nonlinear programming solver 550. For example, neighboring optimal control module 560 may perturb each state variable associated with the trajectory optimization problem and may use nonlinear programming solver 550 to re-calculate the solution using the perturbed state variables. The NOC gains may be provided to the user via user interface 510. Furthermore, neighboring optimal control module 560 may generate a controller block that includes the determined NOC gains and may add the controller block to dynamic system model 110 with a feedback loop to control input vector u 112.

Although FIG. 5 shows exemplary functional components of modeling system 220, in other implementations, modeling system 220 may include fewer functional components, different functional components, differently arranged functional components, or additional functional components than depicted in FIG. 5. Additionally or alternatively, one or more components of modeling system 220 may perform one or more tasks described as being performed by one or more other components of modeling system 220.

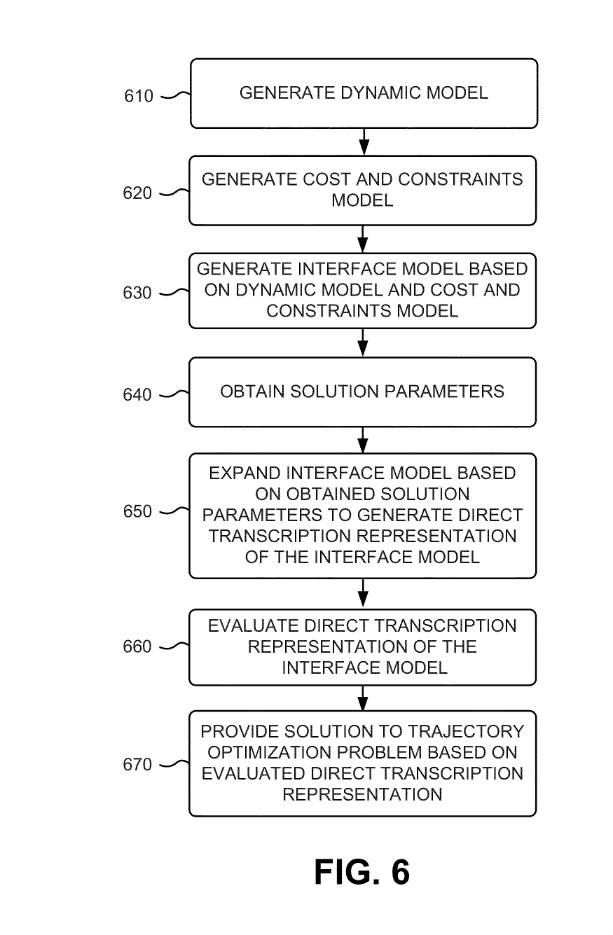

FIG. 6 is a flow diagram of an exemplary process for generating a solution to a trajectory optimization problem according to an implementation described herein. In one implementation, the process of FIG. 6 may be performed by computer device 210. In other implementations, some or all of the process of FIG. 6 may be performed by another device or a group of devices separate from computer device 210 and/or including computer device 210.

The process of FIG. 6 may include generating a dynamic model (block 610). For example, system dynamics module 520 may generate dynamic system model 110 based on input received from the user via user interface 510. As an example, the user may generate a model using modeling system 220 or may import an existing model into modeling system 220 and may identify input and/or output ports that define dynamic system model 110. Thus, the user may select a first input port and identify the first input port as a control vector input u 112, may select a second input port and identify the second input port as state vector input x 114, may select a first output port and identify the first output port as output vector y 116, and may select a second output port and identify the second output port as state derivative vector x 118. As another example, the user may enter one or more equations to define a dynamic system and system dynamics module 520 may generate dynamic system model 110 based on the entered one or more equations.

A cost and constraints model may be generated (block 620). For example, cost and constraints module 530 may generate costs and constraints model 120 based on input received from the user via user interface 510. As an example, the user may generate a model using modeling system 220 or may import an existing model into modeling system 220 and may identify input and/or output ports that define dynamic system model 110. Thus, the user may select a first input port and identify the first input port as output vector y 116, may select a second input port and may identify the second input port as control vector input u 112, may select a first output port and may identify the first output port as integral cost output J 122, may select a second output port and may identify the second output port as terminal cost output j 124, may select a third output port and may identify the third output port as path constraints output E 126, and may select a fourth output port and may identify the fourth output port as terminal constraint output e 128. As another example, the user may enter a cost equation, may enter terminal constraints, and may enter a path constraints equation and cost and constraints module 530 may generate costs and constraints model 120 based on the entered information.

An interface model may be generated based on the dynamic model and based on the cost and constraints model (block 630). For example, interface model module 540 may generate interface model 130 by combining dynamic system model 110 with costs and constraints model 120 such that control vector input u 112 functions as an input to both dynamic system model 110 and costs and constraints model 120 and output vector y 116 of dynamic system model 110 functions as an input to costs and constraints model 120.

Solution parameters may be obtained (block 640). For example, the user may select one or more solution parameters via user interface 510. The user may select the number of nodes for the discretization of interface model 130. In some implementations, the user may select an approximation method used to determine the defects vector. The user may select an initial guess for the solution used by nonlinear programming solver 550 to determine the solution. The user may further select upper and/or lower bounds used by nonlinear programming solver 550 to determine the solution. Thus, nonlinear programming solver 550 may obtain a number of nodes for expanding the generated interface model 130, may obtain an initial guess solution to the trajectory optimization problem, may obtain an upper bound specification for one or more trajectories associated with the trajectory optimization problem, and/or may obtain a lower bound specification for the one or more trajectories.

In some implementations, an initial guess solution may be estimated and provided to the user as a suggestion for specifying the initial guess solution. As an example, nonlinear programming solver 550 may include a database of trajectory optimization problems (e.g., interface models) and corresponding determined solutions and may select a suggestion for the initial guess solution from the determined solutions based on a comparison of the database of trajectory optimization problems to interface model 130. For example, nonlinear programming solver 550 may determine a similarity score between interface model 130 and interface models stored in the database and may select a solution associated with a stored interface model with the highest similarity score.

As another example, nonlinear programming solver 550 may provide a list of trajectory curve types to the user and the user may select a trajectory curve type as an initial guess solution. As yet another example, nonlinear programming solver 550 may generate a population of candidate initial guess solutions and may use a genetic algorithm to select an initial guess solution from the population of initial guess solutions using one or more criteria, such as, for example, rate of convergence. As yet another example, an initial guess solution may be selected through crowdsourcing. For example, selection of the initial guess solution may be outsourced to a community of users and/or developers and may be selected by one or more members of the community. A plurality of initial guess solutions may be selected by the community and nonlinear programming solver 550 may select a particular initial guess solution based on the popularity of each of the solutions included in the plurality of initial guess solutions. Furthermore, a solution library associated with the community may store initial guess solutions associated with particular NLP problems and nonlinear programming solver 550 may access the solution library to select an initial guess solution.

The interface model may be expanded based on the obtained solution parameters to generate a direct transcription representation of the interface model (block 650). For example, interface model module 540 may expand interface model 130 based on solution parameters selected by the user. Interface model module 540 may generate an instance of dynamic system model 110 and costs and constraints model 120 for each node of the nonlinear programming problem corresponding to the trajectory optimization model. The expanded interface model 130 may include as outputs a first state derivatives vector, an integral cost output, a terminal cost output, a path constraints output, and a terminal constraints output. Interface model module 540 may further generate a matrix of coefficients, based on the selected number of nodes and based on the selected approximation method, to determine a second state derivatives vector based on state vector input x 114 and may difference the second state derivatives vector with the first state derivatives vector to obtain a defects vector. The expanded interface model 130 may correspond to the direct transcription representation of interface model 130.

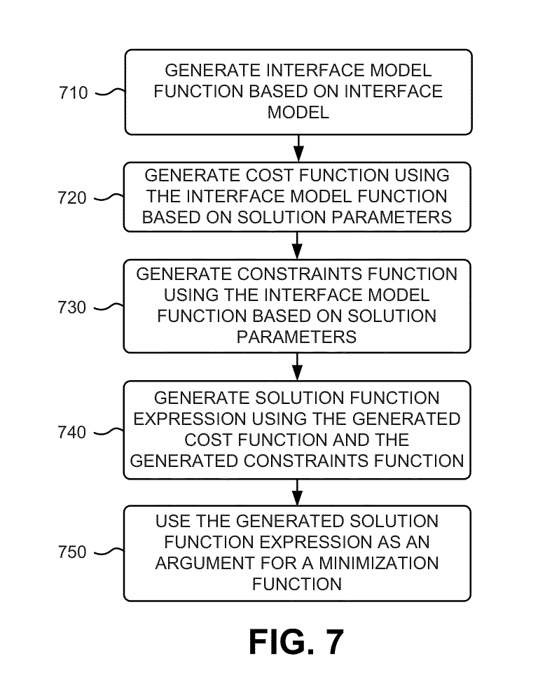

The direct transcription representation of the interface model may be evaluated (block 660). For example, nonlinear programming solver 550 may evaluate the expanded interface model 130 for outputs and state derivatives, subject to the constraints, while minimizing the cost. The process of evaluating the direct transcription representation of the interface model is described below in more detail with reference to FIG. 7.

A solution to a trajectory optimization problem may be provided based on the evaluation of the direct transcription representation (block 670). For example, nonlinear programming solver 550 may determine one or more trajectories that correspond to the minimized cost, while satisfying the constraints, for the dynamic system corresponding to dynamic system model 110. The determined trajectory may include a position and/or a velocity for time values corresponding to the nodes. User interface 510 may generate one or more plots of the one or more trajectories and may generate a user interface that includes the one or more plots and may display the user interface to the user.

In some implementations, at least one of the first executable graphical model or the second executable graphical model may include a time-based block diagram. The time-based block diagram may include a signal or port associated with one or more setting attributes, such as a data type associated with a signal, a numeric type associated with the signal, number of dimensions associated with the signal, a sample time associated with the signal, a minimum value that the signal should have, a maximum value that the signal should have, an initial value assigned to the signal, measurement units assigned to the signal, and/or another type of setting attribute.

User interface 510 may generate the one or more plots based on setting attributes associated, for example, with signals of blocks in dynamic model system 110. The setting attributes may be determined automatically based on signal attributes associated with blocks in the first executable graphical model or the second executable graphical model. A signal attribute may correspond to an input of a block or a set of block, an output of a block or a set of blocks, a state of a block or a set of blocks, and/or a derivative variable of a block or a set of blocks. For example, if an output in output vector 116 includes a position in centimeters, a plot may be generated that includes a graph that shows the position in centimeters. Additionally or alternatively, one or more setting attributes may be based on user input. Thus, the user may select to display a plot in inches and user interface 510 may generate a plot in inches.

FIG. 7 is a flow diagram of an exemplary process for evaluating a direct transcription representation of a graphical model according to an implementation described herein. In one implementation, the process of FIG. 7 may be performed by computer device 210. In other implementations, some or all of the process of FIG. 7 may be performed by another device or a group of devices separate from computer device 210 and/or including computer device 210.

The process of FIG. 7 may include generating an interface model function based on an interface model (block 710). For example, interface model module 540 may generate interface model 130 and may expand interface model 130 as described above with reference to blocks 630 through 650 of FIG. 6. Nonlinear programming solver 550 may generate an interface function that computes a set of outputs and a set of state derivatives based on the interface model. The interface function may be generated in a programming language associated with modeling system 220. For example, the programming language may correspond to the dynamically typed and/or array-based language included in the TCE implemented by modeling system 220.

A cost function may be generated using the interface model function based on the solution parameters (block 720) and a constraints function may be generated using the interface model function based on the solution parameters (block 730). For example, nonlinear programming solver 550 may generate a cost function that calls the interface model function to determine a cost up to the final time associated with the specified terminal constraints. The interface model function may use as parameters the number of controls and the number of states based on the selected number of nodes specified by the solution parameters. Furthermore, nonlinear programming solver 550 may generate a constraints function that calls the interface model function to compute the constraints, including the defects constraints, up to the final time associated with the specified terminal constraints.

A solution function expression may be generated using the cost function and the constraints function (block 740) and the generated solution function expression may be used as an argument for a minimization function (block 750). For example, nonlinear programming solver 550 may generate a solution function expression that includes a call to the generated cost function and a call to the generated constraints function. Furthermore, the solution function expression may include as arguments an initial guess solution, an upper bound for the solution, and/or a lower bound for the solution.

The solution function expression may be used as an argument for a minimization function. For example, nonlinear programming solver 550 may call a minimization function in the programming language associated with modeling system 220, using the solution function expression as the argument for the minimization function.

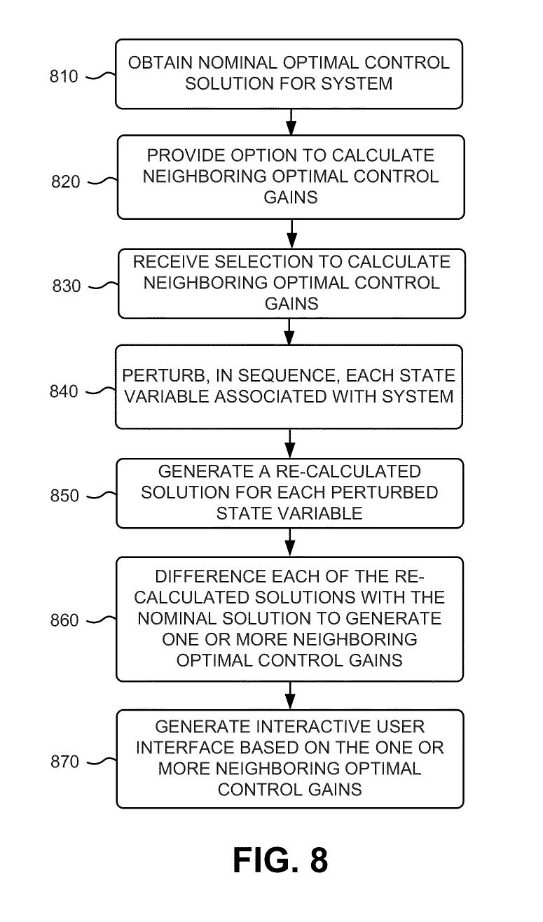

FIG. 8 is a flow diagram of an exemplary process for determining a near optimal control solution according to an implementation described herein. In one implementation, the process of FIG. 8 may be performed by computer device 210. In other implementations, some or all of the process of FIG. 8 may be performed by another device or a group of devices separate from computer device 210 and/or including computer device 210.

The process of FIG. 8 may include obtaining a nominal optical control solution for a system (block 810), an option to compute NOC gains for the obtained nominal solution may be provided (block 820), and a selection to compute the NOC gains may be received (block 830). For example, NOC module 560 may obtain a solution to the trajectory optimization problem defined by expanded interface model 130 from nonlinear programming solver 550. The solution may be displayed to the user via user interface 510 and user interface 510 may include an option to compute the NOC gains. The user may select the option to compute the NOC gains.

Each state variable associated with the system may be perturbed in sequence (block 840) and a re-calculated solution may be generated for each perturbed state variable (block 850). For example, NOC module 560 may perturb a state variable from state vector input x 114 and may re-calculate the solution (e.g., using the process of FIG. 7), using the perturbed state variable. NOC module 560 may repeat the process of perturbing a state variable and re-calculating the solution for each state variable associated with state vector input x 114. Each of the re-calculated solutions may be differenced with the obtained nominal solution to generate one or more NOC gains (block 860). For example, NOC module 560 may difference each of the re-calculated solutions, using Equation (7), to obtain a set of NOC gains.

In other implementations, the NOC gains may be computed in parallel. For example a set (or possibly all) of the state variables may be perturbed in parallel, the solutions based on the set of perturbed states may be re-calculated in parallel, and the NOC gains for the set of state variables may be generated in parallel. NOC module 560 may use processing cluster 250 to perform the parallel computations.

An interactive user interface may be generated based on the one or more NOC gains (block 870). For example, user interface 510 may generate a user interface that may display a solution that may be modified using on one or more perturbations based on the computed NOC gains. For example, user interface 510 may include a selection object that may enable the user to perturb a variable. User interface 510 may be modified to reflect a change in the solution based on the perturbed variable. In some implementations, user interface 510 may generate one or more graphs or animations based on the generated solution, and each of the one or more graphs or animations may display a control signal associated with the trajectory optimization problem. The user may be able to adjust each of the control signals and a displayed graph or animation may be adjusted to reflect a change in a trajectory based on the adjusted control signal.

In some implementations, the NOC gains may be computed using a different technique. For example, the NOC gains may be computed by applying a backward sweep method. In some implementations, the NOC gains may be obtained from information obtained during the minimization of the solution function expression (e.g., as described above with reference to block 750). For example, the NOC gains may represent the changes in the optimal control values associated with control input vector 112 as a function of time for small perturbations in the state variables around the optimal control solution. The changes in the optimal control values may correspond to a time-varying Jacobian matrix associated with expanded interface model 130. A Jacobian matrix, associated with the expanded interface model 130, may be computed during the minimization of the solution function expression and the NOC gains may be determined based on the computed Jacobian matrix. In some implementations, user interface 510 may include an option to generate a controller block that may apply the computed NOC gains to control input vector 112 based on output vector 116. Thus, a closed loop graphical model may be generated with a feedback loop from one or more outputs of dynamic system model 110, corresponding to output vector 116 to one or more inputs of dynamic system model 110, corresponding to control input vector 112.

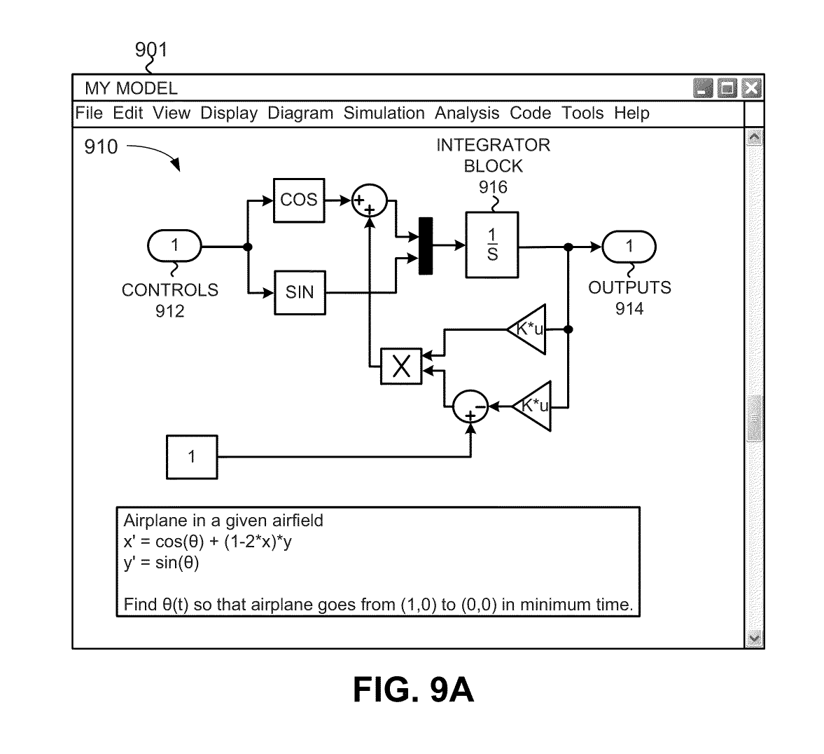

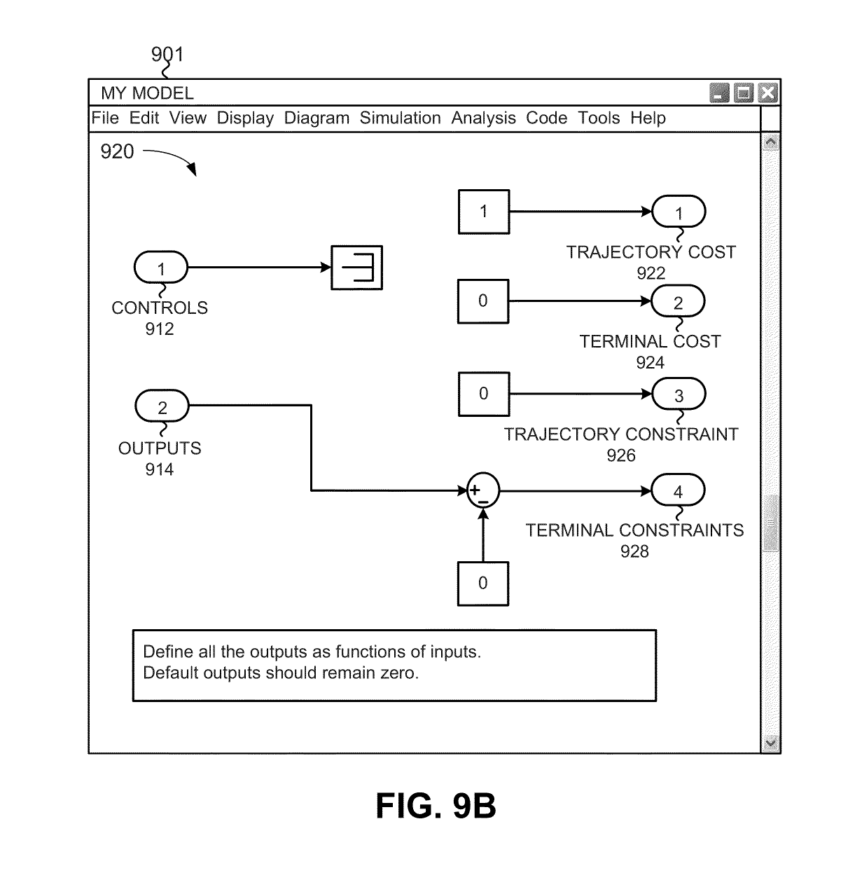

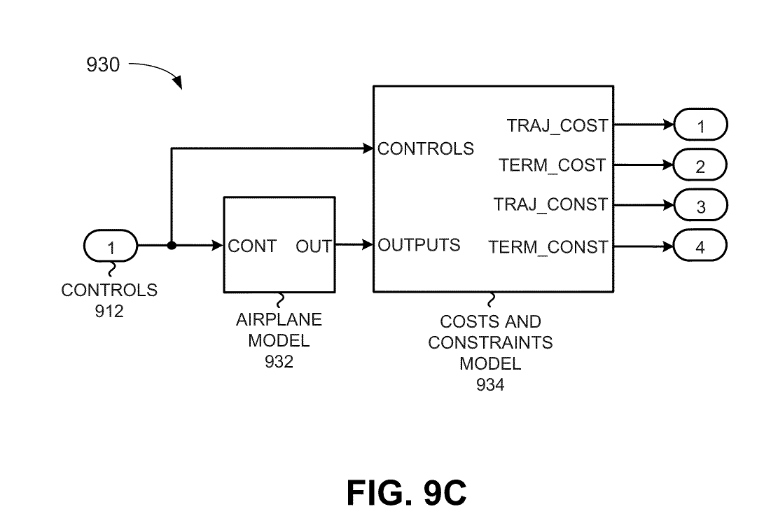

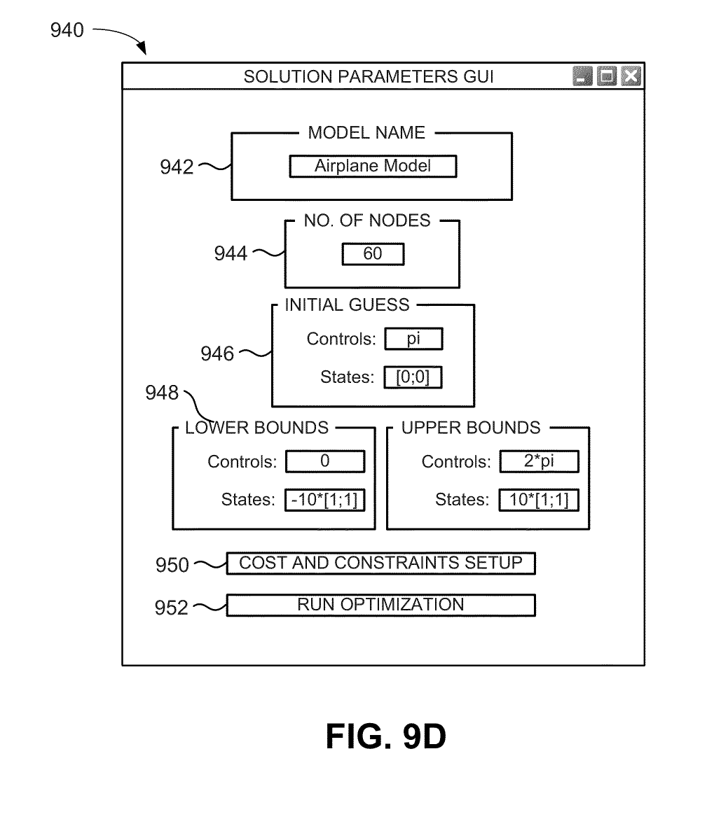

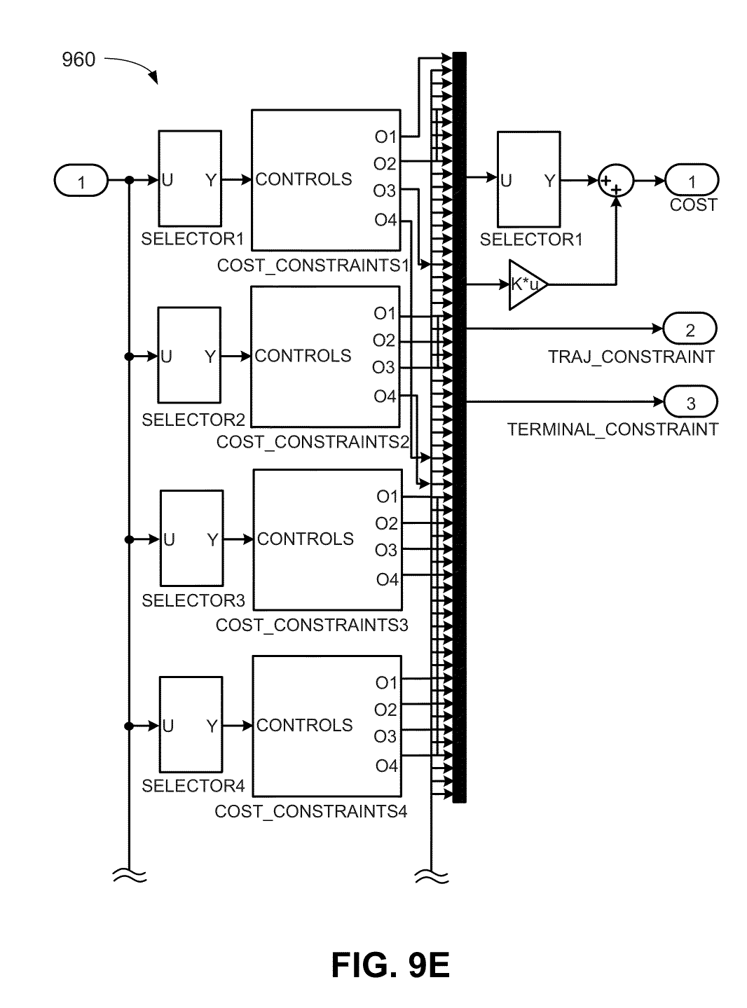

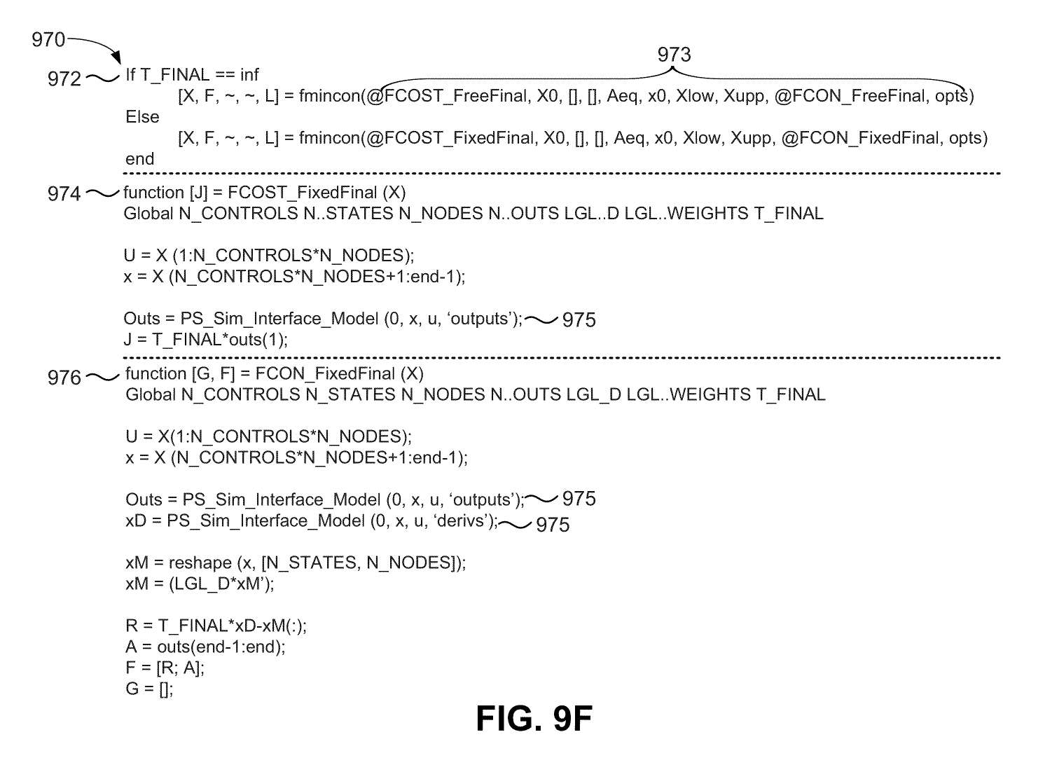

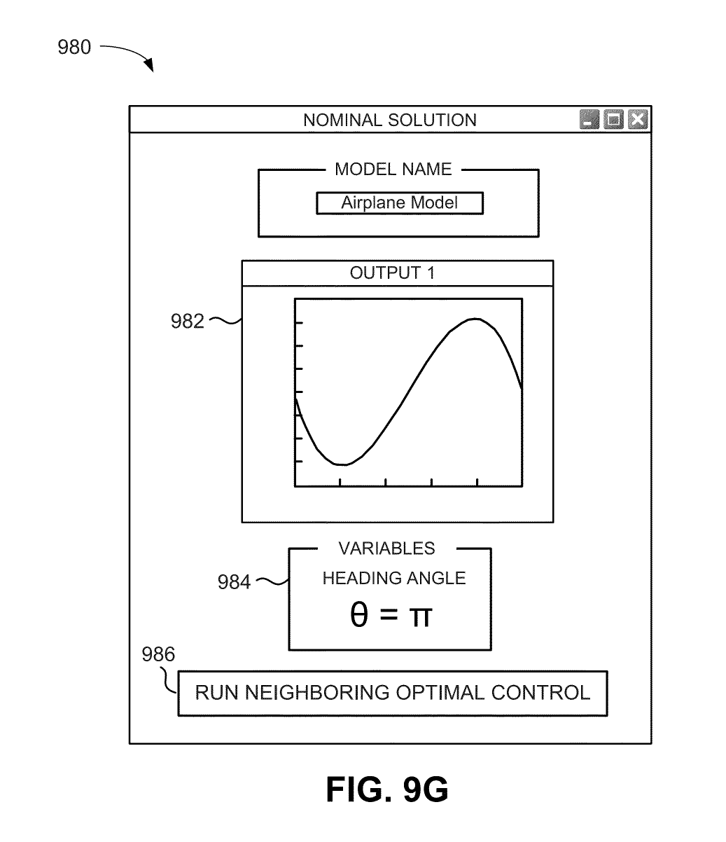

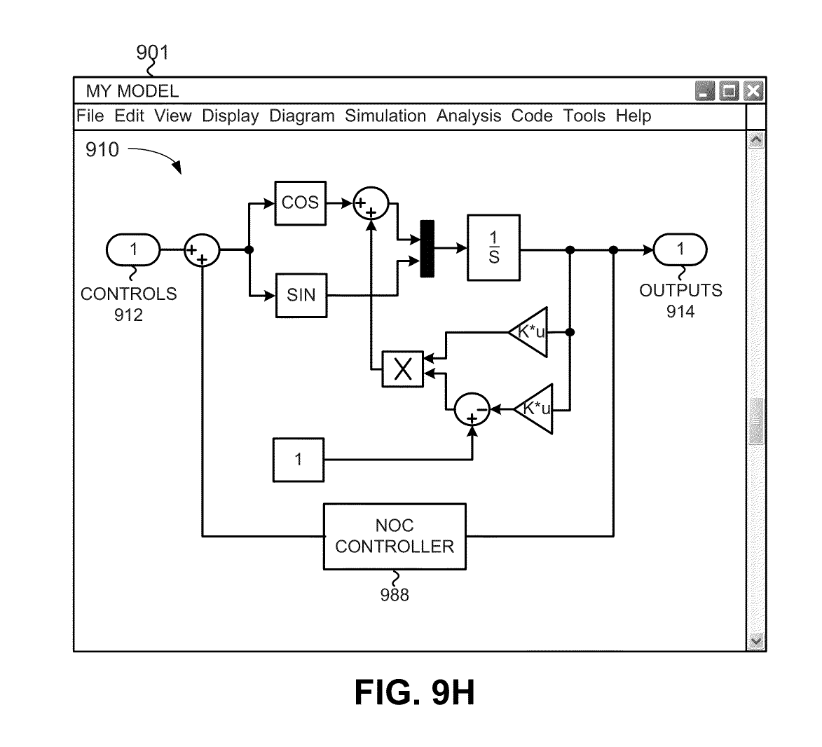

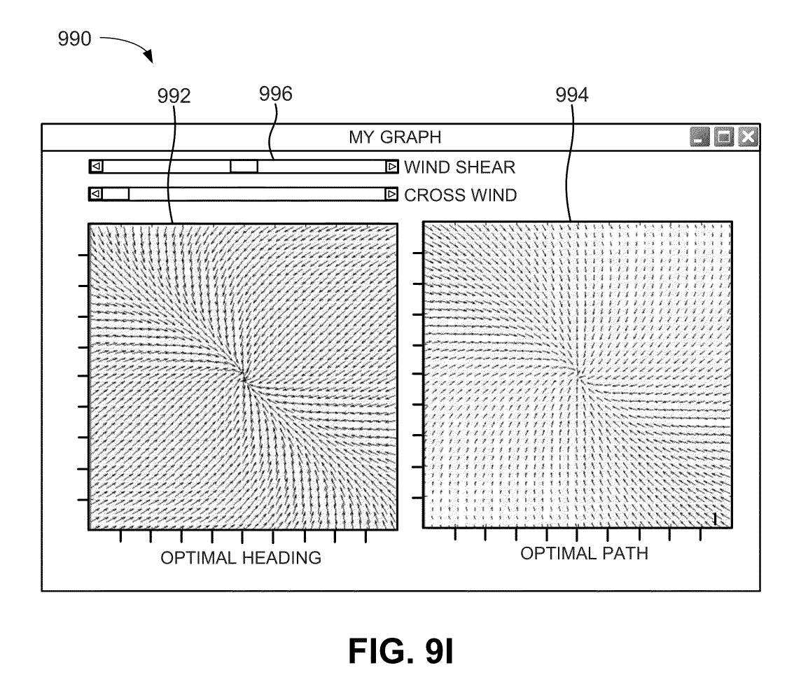

FIGS. 9A-9I are exemplary diagrams of an example of using framework 100 to generate a solution to a trajectory optimization problem according to an implementation described herein. FIG. 9A illustrates a user interface 901, associated with modeling system 220, which includes a first model 910. Model 910 may correspond to dynamic system model 110. Model 910 may represent a dynamic system characterizing an aircraft in a given airfield and described by the differential equations:

x′=cos(θ)+(1−2x)·y

y′=sin(θ)

In Equation (8), x and y may correspond to the position of the aircraft at time t. A trajectory optimization problem associated with first model 910 may be to find θ(t) so that the aircraft goes from position (1,0) to position (0,0) in minimum time. First model 910 may model Equation (8) and may include a control inputs block 912, corresponding to control vector input u 112, and outputs block 914, corresponding to output vector y 116. Furthermore, first model 910 may include integrator block 916, which may be associated with states that define state vector input x 114.

FIG. 9B illustrates user interface 901 with a second model 920. Second model 920 may correspond to costs and constraints model 120. Second model 920 may be generated automatically based on costs and constraints defined by the user, via a user interface, for first model 910. Second model 920 may include control inputs block 912 from first model 910, which may not be used to determine any outputs in second model 920. Furthermore, second model 920 may include outputs block 914 from first model 910. Furthermore, second model 920 may include a trajectory costs block 922, a terminal costs block 924, a trajectory constraints block 926, and a terminal constraints block 928. Trajectory costs block 922 may output the trajectory costs associated with the trajectory determined by first model 910, which may be constant for each time step. Terminal costs block 924 may output the terminal costs for the trajectory, which may be set to zero. Trajectory constraints block 926 may output the trajectory constraints for the trajectory, which may also be set to zero. Terminal constraints block 928 may output the terminal constraints for the trajectory, which may be based on outputs block 914 from first model 910.

FIG. 9C illustrates a third model 930 based on first model 910 and second model 920. Third model 930 may correspond to interface model 130 and may thus be generated in the background and may not be displayed to the user. Third model 930 may include controls input block 912 from first model 910, an aircraft model block 932, and a costs and constraints model block 934. Aircraft model block 932 may correspond to a subsystem block that may represent first model 910 and costs and constraints model block 934 may correspond to a subsystem block that may represent second model 920. In some embodiments, the subsystem blocks may reference first model 910 and/or second model 920, wherein first model 910 and/or second model 920 are stored separately from third model 930 (e.g., by a model reference mechanism). As shown in FIG. 9C, the outputs and inputs of first model 910 and second model 920 may be coupled in third model 930.

FIG. 9D illustrates a user interface 940 used by modeling system 220 to obtain solution parameters for solving a trajectory optimization problem defined by third model 930. As shown in FIG. 9D, user interface 940 may include a model name field 942, a number of nodes field 944, an initial guess field 946, a bound field 948, a costs and constraints setup button 950, and a run optimization button 952.

Model name field 942 may enable a user to name first model 910. Number of nodes field 944 may enable the user to specify the number of nodes for the discretization of the trajectory optimization problem defined by first model 910 and second model 920. Initial guess field 946 may enable the user to specify an initial guess for solving the nonlinear programming problem associated with the discretized trajectory optimization problem. Bounds field 948 may enable the user to specify lower and upper bounds for the solution of the nonlinear programming problem. Costs and constraints setup button 950 may enable the user to modify second model 920. Run optimization button 952 may enable the user to solve the nonlinear programming problem.

FIG. 9E illustrates a fourth model 960, which may correspond to third model 930 expanded based on the solution parameters obtained using user interface 940. Fourth model 960 may correspond to expanded interface model 130 and may thus be generated in the background and may not be displayed to the user. As shown in FIG. 9E, fourth model 960 may include an instance of third model 930 for each node of the nonlinear programming problem associated with the discretized trajectory optimization problem, based on the number of nodes selected by the user. Fourth model 960 may be evaluated using an interface model function generated based on fourth model 960.

FIG. 9F illustrates functions 970 that may be generated based on third model 930 and fourth model 960. Functions 970 may include a minimization function expression 972, a cost function 974, and a constraints function 976.

Minimization function expression 972 may call a minimization function fmincon, which may take a solution function expression 973 for arguments. Minimization function expression 972 may perform a first call to fmincon if the final time for the trajectory optimization problem is not specified and may perform a second call to fmincon if the final time for the trajectory optimization function is specified. Solution function expression 973 may include a reference to cost function 974, a reference to constraints function 976, may include an initial guess solution argument, and/or may include upper and lower bounds arguments.

Cost function 974 may call an interface function 975 to determine costs associated with fourth model 960. Interface function 975 may evaluate fourth model 960. Constraints function 976 may call interface function 975 to determine constraints associated with fourth model 960, including the evaluation of the defect constraints. Minimization function fmincon may minimize cost function 974 while satisfying the constraints determined by constraints function 976.

FIG. 9G illustrates a user interface 980, which may include a solution generated using functions 970. User interface 980 may include a trajectory plot section 982, a variable section 984, and an NOC button 986. Trajectory plot section 982 may display a plot of the trajectory associated with the determined solution. Variable section 984 may display values for the θ variable associated with the determined solution. NOC button 986 may enable the user to select to compute NOC gains associated with the determined solution. If the user selects NOC button 986, the NOC gains may be computed.

FIG. 9H illustrates first model 910 with a controller block that includes NOC gains computed for first model 910. As shown in FIG. 9H, first model 910 may include NOC controller 988. NOC controller 988 may include as an input the outputs received by outputs block 914, corresponding to output vector y 116 of dynamic system model 110. NOC controller 988 may apply determined NOC gains to output vector y 116 to determine adjustments to be made to control inputs block 912.

FIG. 9I illustrates a user interface 990, which may include a solution associated with NOC gains computed for first model 910. As shown in FIG. 9I, user interface 990 may include an optimal heading plot 992, an optimal path plot 994, and a wind selection object 996. The wind shear and the cross wind may correspond to controls used to determine the trajectory for the aircraft. The wind shear and cross wind were assumed to be constant controls for computing the nominal solution displayed in user interface 980 of FIG. 9G. The computed NOC gains may be used to determine the change in the optimized trajectory in response to a change in the wind shear or cross wind. Thus, the user may adjust the wind shear and the cross wind for the airfield through which the aircraft is flying using wind selection object 996. The optimal heading and the optimal path may be adjusted using the computed NOC gains and optimal heading plot 992 and optimal path plot 994 may be changed to display the adjusted optimal heading and optimal path.

The foregoing description provides illustration and description, but is not intended to be exhaustive or to limit the implementations to the precise form disclosed. Modifications and variations are possible in light of the above teachings or may be acquired from practice of the described implementations.

For example, while series of blocks have been described with respect to FIGS. 6-8, the order of the blocks may be modified in other implementations. Further, non-dependent blocks may be performed in parallel.

Also, certain portions of the implementations may have been described as a “component,” “logic,” “tool,” “engine,” and/or “system” that performs one or more functions. The described “component,” “logic,” “tool,” “engine,” and/or “system” may include hardware, such as a processor, an ASIC, or a FPGA, or a combination of hardware and software (e.g., software running on a processor).

It will be apparent that aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the description of the present application should be construed as critical or essential to the invention unless explicitly described as such. Also, as used herein, the article “a” is intended to include one or more items. Further, the phrase “based on,” as used herein is intended to mean “based, at least in part, on” unless explicitly stated otherwise.

What is claimed is:

1. A method comprising:
generating a first executable graphical model representing a dynamic system, wherein the generating is performed by a computer device;
generating a second executable graphical model representing costs and constraints associated with the dynamic system, wherein the generating is performed by the computer device;
generating an interface model based on the first executable graphical model and based on the second executable graphical model, wherein the generating is performed by the computer device;
obtaining one or more solution parameters for solving a trajectory optimization problem defined by the dynamic system and the cost and constraints, wherein the obtaining is performed by the computer device;
expanding the generated interface model based on the obtained one or more solution parameters to generate a direct transcription representation of the trajectory optimization problem, wherein the expanding is performed by the computer device;
evaluating the expanded interface model to obtain a solution to the trajectory optimization problem, wherein the simulation is performed by the computer device; and
providing, in an interface, the obtained solution as a solution to the trajectory optimization problem, wherein the solution to the trajectory optimization problem has a reduced cost compared to a cost associated with an initial guess solution, and wherein the providing is performed by the computer device.

2. The method of claim 1, wherein the generated solution corresponds to a substantially minimum cost optimal solution to the trajectory optimization problem.

3. The method of claim 1, wherein obtaining the one or more solution parameters, for solving the trajectory optimization problem associated with the dynamic system and the cost and constraints, includes at least one of:
obtaining a number of nodes for expanding the generated the interface model;
obtaining an initial guess solution to the trajectory optimization problem;
obtaining an upper bound specification for one or more trajectories associated with the trajectory optimization problem; or
obtaining a lower bound specification for the one or more trajectories.

4. The method of claim 3, wherein expanding the generated interface model based on the obtained one or more solution parameters includes:
generating a number of instances of the generated interface model, wherein the number of instances corresponds to the obtained number of nodes.

5. The method of claim 4, further comprising:
generating an interface model function that computes a set of outputs and a set of state derivatives based on the expanded interface model.

6. The method of claim 5, wherein evaluating the direct transcription representation of the generated interface model to obtain a solution to the trajectory optimization problem includes:
generating a costs function that calls the generated interface function to determine the costs associated with a trajectory; and
generating a constraints function that calls the generated interface function to determine the constraints associated with the trajectory.

7. The method of claim 6, further comprising:
generating a solution function expression that includes a call to the generated costs function, a call to the generated constraints function, the initial guess solution, the lower bound specification, and the upper bound specification.

8. The method of claim 7, further comprising:
calling a minimization function in a programming language using the solution function expression as an argument for the minimization function.

9. The method of claim 1, further comprising:
computing one or more neighboring optimal control gains associated with the trajectory optimization problem.

10. The method of claim 9, wherein computing one or more neighboring optimal control gains associated with the trajectory optimization problem includes:
perturbing, in sequence, each state variable associated with the trajectory optimization problem:
generating at least one re-calculated solution for each perturbed state variable; and
differencing each of the at least one re-calculated solutions and the generated solution to the trajectory optimization problem to obtain one or more neighboring optimal control gains associated with the trajectory optimization problem.

11. The method of claim 10, further comprising:
generating a controller block configured to:
receive, as an input, an output of the first executable graphical model;
apply the neighboring optimal control gains to the received input; and
adjust a control input to the first executable graphical model based on the applied neighboring optimal control gains.

12. The method of claim 9, wherein computing the one or more neighboring optimal control gains associated with the trajectory optimization problem includes:
applying a backward sweep method to generate the one or more neighboring optimal control gains.

13. The method of claim 1, further comprising:
generating one or more graphs or animations based on the obtained solution, wherein each of the one or more graphs or animations displays a control signal associated with the trajectory optimization problem.

14. The method of claim 13, wherein at least one of the one or more graphs or animations includes an interaction object to adjust a control signal associated with the trajectory optimization problem, the method further comprising:
receiving a request, via the interaction object, to adjust the control signal; and
adjusting the at least one of the one or more graphs based on the adjusted control signal.

15. The method of claim 1, wherein at least one of the first executable graphical model or the second executable graphical model includes a time-based block diagram, the method further comprising:
generating the interface based on one or more setting attributes associated with a signal or a port of the time-based block diagram.

16. The method of claim 15, wherein generating the interface based on the one or more setting attributes includes:
determining the one or more setting attributes based on user input; or
automatically determining the one or more setting attributes based on the first executable graphical model or the second executable graphical model.

17. The method of claim 15, wherein the one or more setting attributes include at least one of an input, an output, a state, or a derivative variable.

18. A non-transitory computer-readable medium containing one or more instructions executable by at least one processor, the computer-readable medium comprising:
one or more instructions to generate a first executable graphical model representing a dynamic system;
one or more instructions to generate a second executable graphical model representing costs and constraints associated with the dynamic system;
one or more instructions to generate an interface model based on the first executable graphical model and based on the second executable graphical model;
one or more instructions to obtain one or more solution parameters for solving a trajectory optimization problem defined by the dynamic system and the cost and constraints;
one or more instructions to expand the generated interface model based on the obtained one or more solution parameters to generate a direct transcription representation of the generated interface model;
one or more instructions to evaluate the direct transcription representation of the generated interface model to obtain a solution to the trajectory optimization problem; and
one or more instructions to provide, in an interface, the obtained solution as a solution to the trajectory optimization problem, wherein the solution to the trajectory optimization problem has a reduced cost compared to a cost associated with an initial guess solution.

19. The non-transitory computer-readable medium of claim 18, wherein the generated solution corresponds to a substantially minimum cost optimal solution to the trajectory optimization problem.

20. The non-transitory computer-readable medium of claim 18, wherein the one or more instructions to obtain the one or more solution parameters include:
one or more instructions to obtain a number of nodes for expanding the generated the interface model;
one or more instructions to obtain an initial guess solution to the trajectory optimization problem;
one or more instructions to obtain an upper bound specification for one or more trajectories associated with the trajectory optimization problem; or
one or more instructions to obtain a lower bound specification for the one or more trajectories.

21. The non-transitory computer-readable medium of claim 18, wherein the one or more instructions to expand the generated interface model based on the obtained one or more solution parameters include at least one of:
one or more instructions to generate a number of instances of the generated interface model, wherein the number of instances corresponds to the obtained number of nodes.

22. The non-transitory computer-readable medium of claim 21, further comprising:
one or more instructions to generate an interface model function that computes a set of outputs and a set of state derivatives based on the expanded interface model.

23. The non-transitory computer-readable medium of claim 22, wherein the one or more instructions to evaluate the direct transcription representation of the generated interface model include:
one or more instructions to generate a costs function that calls the generated interface function to determine the costs associated with a trajectory; and
one or more instructions to generate a constraints function that calls the generated interface function to determine the constraints associated with the trajectory.

24. The non-transitory computer-readable medium of claim 23, further comprising:
one or more instructions to generate a solution function expression that includes a call to the generated costs function, a call to the generated constraints function, the initial guess solution, the lower bound specification, and the upper bound specification.

25. The non-transitory computer-readable medium of claim 24, wherein the one or more instructions to minimize the solution function include:
one or more instructions to call a minimization function in a programming language using the solution function expression as an argument for the minimization function.

26. The non-transitory computer-readable medium of claim 18, further comprising:
one or more instructions to compute one or more neighboring optimal control gains associated with the trajectory optimization problem.

27. The non-transitory computer-readable medium of claim 26, wherein computing one or more neighboring optimal control gains associated with the trajectory optimization problem includes:
one or more instructions to perturb, in sequence, each state variable associated with the trajectory optimization problem;
one or more instructions to generate at least one re-calculated solution for each perturbed state variable; and
one or more instructions to difference each of the at least one re-calculated solutions and the generated solution to the trajectory optimization problem to obtain one or more neighboring optimal control gains associated with the trajectory optimization problem.

28. The non-transitory computer-readable medium of claim 27, further comprising:
one or more instructions to generate a controller block configured to:
receive, as an input, an output of the first executable graphical model;
apply the neighboring optimal control gains to the received input; and
adjust a control input to the first executable graphical model based on the applied neighboring optimal control gains.

29. The non-transitory computer-readable medium of claim 26, wherein the one or more instructions to compute the one or more neighboring optimal control gains associated with the trajectory optimization problem include:
one or more instructions to apply a backward sweep method to generate the one or more neighboring optimal control gains.

30. The non-transitory computer-readable medium of claim 18, further comprising:
one or more instructions to generate one or more graphs or animations based on the generated solution, wherein each of the one or more graphs or animations displays a control signal associated with the trajectory optimization problem.

31. The non-transitory computer-readable medium of claim 30, wherein at least one of the one or more graphs or animations includes an interaction object to adjust a control signal associated with the trajectory optimization problem, the non-transitory computer-readable medium further comprising:
one or more instructions to receive a request, via the interaction object, to adjust the control signal; and
one or more instructions to adjust the at least one of the one or more graphs based on the adjusted control signal.

32. The non-transitory computer-readable medium of claim 18, wherein at least one of the first executable graphical model or the second executable graphical model includes a time-based block diagram, the non-transitory computer-readable medium further comprising:
one or more instructions to generate the interface based on one or more setting attributes associated with a signal or a port of the time-based block diagram.

33. The non-transitory computer-readable medium of claim 32, wherein the one or more instructions to generate the interface based on the one or more setting attributes includes:
one or more instructions to determine the one or more setting attributes based on user input; or
one or more instructions to automatically determine the one or more setting attributes based on the first executable graphical model or the second executable graphical model.

34. The non-transitory computer-readable medium of claim 32, wherein the one or more setting attributes include at least one of an input, an output, a state, or a derivative variable.

35. A computing device, in a technical computing environment, comprising:
a memory to store a first executable graphical model representing a dynamic system and a second executable graphical model representing costs and constraints associated with the dynamic system; and
a processor configured to:
generate an interface model based on the first executable graphical model and based on the second executable graphical model;
obtain one or more solution parameters for solving a trajectory optimization problem defined by the dynamic system and the cost and constraints;
expand the generated interface model based on the obtained one or more solution parameters to generate a direct transcription representation of the generated interface model;
evaluate the direct transcription representation of the generated interface model to obtain a solution to the trajectory optimization problem; and
provide, in an interface, the obtained solution as a solution to the trajectory optimization problem, wherein the solution to the trajectory optimization problem has a reduced cost compared to a cost associated with an initial guess solution.
